(19) United States
(12) Patent Application Publication
(10) Pub. No.: US 2016/0154091 A1
(43) Pub. Date: Jun. 2, 2016

(54) RADAR TRANSMITTER AND RADAR RECEIVER

(71) Applicant: Panasonic Corporation, Osaka (JP)

(72) Inventors: NAOYA YOSOKU, Kanagawa (JP); TAKAAKI KISHIGAMI, Tokyo (JP)

(21) Appl. No.: 14/918,951

(22) Filed: Oct. 21, 2015

(30) Foreign Application Priority Data
Nov. 28, 2014 (JP) 2014-242008

(51) Int. Cl. G01S 7/28; G01S 7/285; G01S 7/282

(52) U.S. Cl. CPC G01S 7/28; G01S 7/282; G01S 7/285

(57) ABSTRACT

A radar transmitter includes a signal generator that generates a plurality of signals, each signal corresponding to respective one of a plurality of transmission branches, a modulator that modulates each of the plurality of generated signals, a frequency shifter that provides one of a plurality of frequency shifts respectively to one of the plurality of modulated signals, where each of the plurality of frequency shifts has corresponding one of a plurality of frequency shift amounts, each frequency shift amount being a multiple of a predetermined period, and where each of the plurality of frequency shift amounts respectively corresponding to the plurality of transmission branches differ from each other, and a radio transmitter that transmits a plurality of frequency shifted signals as radar signals.

### BACKGROUND

1. Technical Field

The present disclosure relates to a radar transmitter and a radar receiver.

2. Description of the Related Art

Various techniques related to application of multiple-input and multiple-output (MIMO) are conventionally proposed (see for example, Japanese Unexamined Patent Application Publication No. 2014-119344).

A radar device described in Japanese Unexamined Patent Application Publication No. 2014-119344 provides a Doppler shift amount larger than a Doppler bandwidth to signals other than a reference signal, which are included in transmission signals emitted from a plurality of transmission antennas. Further, the radar device receives a reflected wave of each of the transmission signals, which is reflected by a target, or an object to be detected, using each of a plurality of reception antennas, and estimates the position of the target that has reflected the transmitted pulse or the relative velocity (Doppler frequency) by separating and analyzing signal components on a Doppler frequency axis.

Thus, the radar device enables high-resolution target detection through virtual antenna arrangement that involves arrangement of the plurality of transmission antennas and arrangement of the plurality of reception antennas.

However, according to such conventional techniques, signal interference among a plurality of transmission branches or interference between adjacent channels lowers the accuracy of target detection.

### SUMMARY

One non-limiting and exemplary embodiment provides a radar transmitter and a radar receiver capable of detecting a target with high accuracy.

In one general aspect, the techniques disclosed here feature a radar transmitter including: a signal generator that generates a plurality of signals respectively corresponding to a plurality of transmission branches; a modulator that modulates each of the plurality of generated signals; a frequency shifter that provides a frequency shift to each of the plurality of modulated signals, where the frequency shift provided to each modulated signal has corresponding one of a plurality of frequency shift amounts, each frequency shift amount being a multiple of a predetermined period, and where the plurality of frequency shift amounts respectively corresponding to the plurality of transmission branches differ from each other; and a radio transmitter that transmits the plurality of frequency shifted signals as radar signals.

It should be noted that general or specific embodiments may be implemented using a device, a system, a method, an integral circuit and a computer program, and any combination thereof.

The present disclosure enables a target to be detected with high accuracy.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates an example of a configuration of a radar device according to an embodiment of the present disclosure;

FIG. 2 illustrates an example of a configuration of a frequency shifter according to the embodiment;

FIG. 3 illustrates an example of a configuration of a radio transmitter according to the embodiment;

FIG. 4 illustrates an example of a configuration of a correlator according to the embodiment;

FIG. 5 illustrates an example of a configuration of a correlator group according to the embodiment;

FIG. 6 illustrates an example of a configuration of a coherent adder according to the embodiment;

FIG. 7 illustrates an example of a configuration of a Doppler analyzer according to the embodiment;

FIG. 8 illustrates an example of a transmission time control process according to the embodiment;

FIG. 9 illustrates an example of an orthogonal coding process according to the embodiment;

FIG. 10 illustrates another example of the orthogonal coding process according to the embodiment;

FIG. 11 illustrates an example of a frequency shift process based on an orthogonal code period according to the embodiment;

FIG. 12 illustrates an example of a frequency spectrum of each of radar signals according to the embodiment;

FIG. 13 illustrates an example of a reference timing of coherent addition according to the embodiment;

FIG. 14 illustrates an example of an output timing of a coherent addition result according to the embodiment;

FIG. 15 illustrates an example of an interleave process according to the embodiment;

FIG. 16 illustrates an example of a data configuration of a distance-Doppler map according to the embodiment;

FIG. 17 illustrates an example of a Doppler analysis result according to the embodiment;

FIG. 18 illustrates an example of operation of the radar device according to the embodiment;

FIG. 19 illustrates an example of a frequency shift process based on a coherent addition period according to the embodiment;

FIG. 20 illustrates an example of a frequency shift process based on a Doppler analysis period according to the embodiment;

FIG. 21 illustrates an example of a frequency shift process based on a complementary code period according to the embodiment;

FIG. 22 illustrates an example of a frequency shift component discretized on the basis of a transmission repetition period according to the embodiment;

FIG. 23 illustrates an example of the frequency shift component discretized on the basis of a complementary code period according to the embodiment;

FIG. 24 illustrates an example of the frequency shift component discretized on the basis of an orthogonal code period according to the embodiment;

FIG. 25 illustrates an example of the frequency shift component discretized on the basis of the coherent addition period according to the embodiment;

FIG. 26 illustrates another example of the configuration of the radar device according to the embodiment;

FIG. 27 illustrates an example of a configuration of a frequency shift demodulator according to the embodiment;

FIG. 28 illustrates an example of a configuration of a demodulator group according to the embodiment;

FIG. 29 illustrates another example of the data configuration of the distance-Doppler map according to the embodiment;

FIG. 30 illustrates an example of a Doppler spectrum according to the embodiment;

FIG. 31 illustrates an example of the Doppler spectrum after increase in the number of times of performing the coherent addition according to the embodiment;

FIG. 32 illustrates a first example of allocation of frequency shift amounts to transmission branches according to the embodiment;

FIG. 33 illustrates a second example of the allocation of the frequency shift amounts to the transmission branches according to the embodiment; and

FIG. 34 illustrates an example of allocation of transmission timing offset amounts to the transmission branches according to the embodiment.

### DETAILED DESCRIPTION

An embodiment of the present disclosure is described in detail below with reference to the drawings.

### [Configuration of Radar Device]

A configuration of a radar device 100 according to the present embodiment is described first, which includes a radar transmitter 200 and a radar receiver 300.

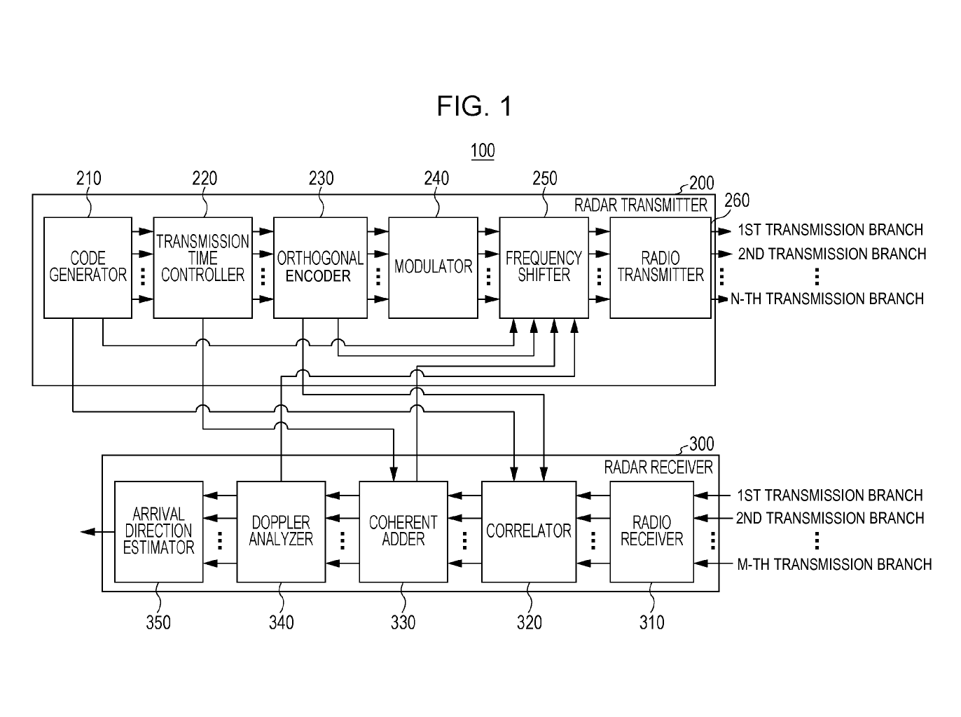

FIG. 1 illustrates an example of the configuration of the radar device 100 according to the present embodiment.

As illustrated in FIG. 1, the radar device 100 includes the radar transmitter 200, which outputs radar signals using first to N-th transmission branches, and the radar receiver 300, which receives echo signals using first to M-th reception branches. The echo signal is a radar signal reflected from a target, which is an object to be detected. For example, the transmission branches correspond to N transmission antennas. For example, the reception branches correspond to M reception antennas.

The configuration of the radar transmitter 200 is now described. The radar transmitter 200 includes a code generator 210, a transmission time controller 220, an orthogonal encoder 230, a modulator 240, a frequency shifter 250, and a radio transmitter 260. The code generator 210, the transmission time controller 220, and the orthogonal encoder 230 correspond to a signal generator according to the present disclosure.

The code generator 210 generates pulse compression codes that correspond to first to N-th transmission branches and outputs the generated pulse compression codes at certain time intervals. For example, a pseudo noise (PN) code, an m-sequence, a Golay code, or a Spano code may be employed as the pulse compression code. The plurality of pulse compression codes that are repeatedly output for an identical transmission branch may be the same or different. The N pulse compression codes that are output so as to correspond to the first to N-th transmission branches may be the same or different.

The transmission time controller 220 controls a timing at which each of the pulse compression codes output from the code generator 210 is transmitted to a subsequent stage for each of the first to N-th transmission branches. That is, the transmission time controller 220 controls a timing at which each of radar signals that correspond to the first to N-th transmission branches is output from the radar transmitter 200. The transmission time control is described in detail below.

In regard to each of the first to N-th transmission branches, the orthogonal encoder 230 superimposes an orthogonal code on the pulse compression code transmitted from the transmission time controller 220 and outputs the pulse compression code on which the orthogonal code is superimposed. For example, a Walsh code may be employed as the orthogonal code. The orthogonal encoder 230 uses orthogonal code sequences that differ from transmission branch to transmission branch among the first to N-th transmission branches. The orthogonal coding is described in detail below.

In regard to each of the first to N-th transmission branches, the modulator 240 modulates the signal output from the orthogonal encoder 230, which is the pulse compression code (sequence) on which the orthogonal code is superimposed, and outputs the resultant signal as a modulation signal. For example, binary phase-shift keying (BPSK) may be employed as a modulation scheme.

In regard to each of the first to N-th transmission branches, the frequency shifter 250 provides a frequency shift to the modulation signal output from the modulator 240 and outputs the modulation signal provided with the frequency shift. The amount of the frequency shift, which is hereinafter referred to as the “frequency shift amount,” is determined on the basis of for example, an orthogonal code period used for the generation of the original signal, which is the pulse compression code on which the orthogonal code is superimposed, and is a frequency shift amount that differs from transmission branch to transmission branch among the first to N-th transmission branches.

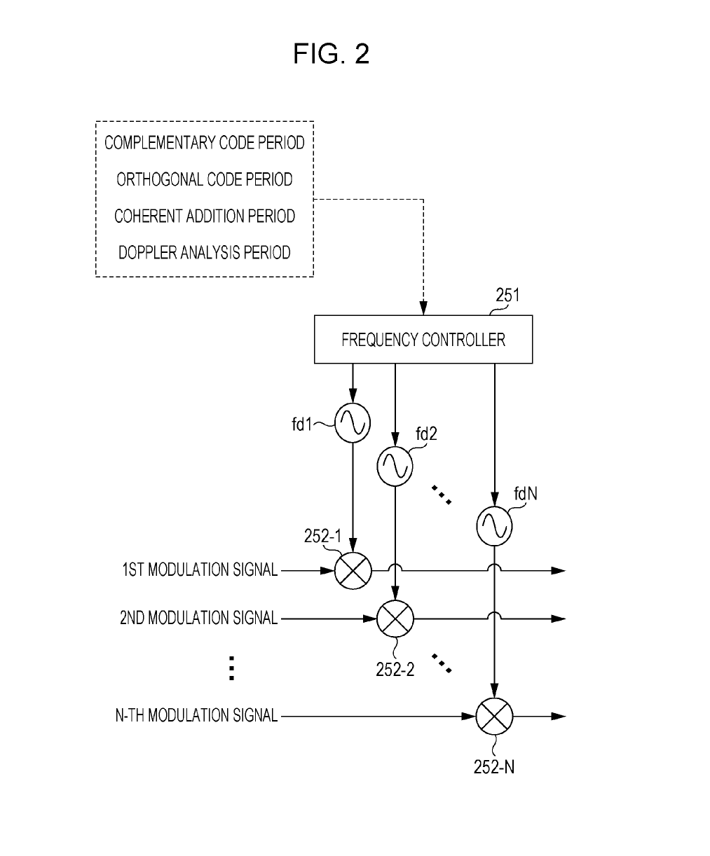

FIG. 2 illustrates an example of a configuration of the frequency shifter 250.

As illustrated in FIG. 2, the frequency shifter 250 includes a frequency controller 251 and first to N-th multipliers 252-1 to 252-N that correspond to the first to N-th transmission branches.

First to N-th frequency shift amounts fd1 to fdN to be provided to the modulation signals of the first to N-th transmission branches are preset in the frequency controller 251. The first to N-th frequency shift amounts fd1 to fdN are used in the radar device 100 and are frequencies determined on the basis of at least one of a complementary code period, the orthogonal code period, a coherent addition period, and a Doppler analysis period.

First to N-th modulation signals that correspond to the first to N-th transmission branches are input to the first to N-th multipliers 252-1 to 252-N, respectively. The frequency controller 251 outputs a signal with a frequency of corresponding one of the first to N-th frequency shift amounts fd1 to fdN to the multiplier 252 of the corresponding branch. The n-th multiplier 252-n upconverts the n-th modulation signal using the n-th frequency shift amount fdn. The frequency shifter 250 provides the first to N-th modulation signals with the first to N-th frequency shift amounts fd1 to fdN. The complementary code period, the orthogonal code period, the coherent addition period, and the Doppler analysis period are described in detail below.

For example, the radio transmitter 260 in FIG. 1 converts the output signals from the frequency shifter 250 into radio signals and transmits the resultant signals as radar signals using the not-illustrated N transmission antennas connected to the first to N-th transmission branches, respectively. A frequency fc of a local oscillation signal used in the conversion into the radio signals is identical for each of the first to N-th transmission branches.

A transmission timing offset amount Tofst,n for causing the transmission time periods occupied by the first to N-th transmission branches not to overlap is set for each of the transmission branches, a radio transmission circuit 262 of the radio transmitter 260 may be implemented by a single branch.

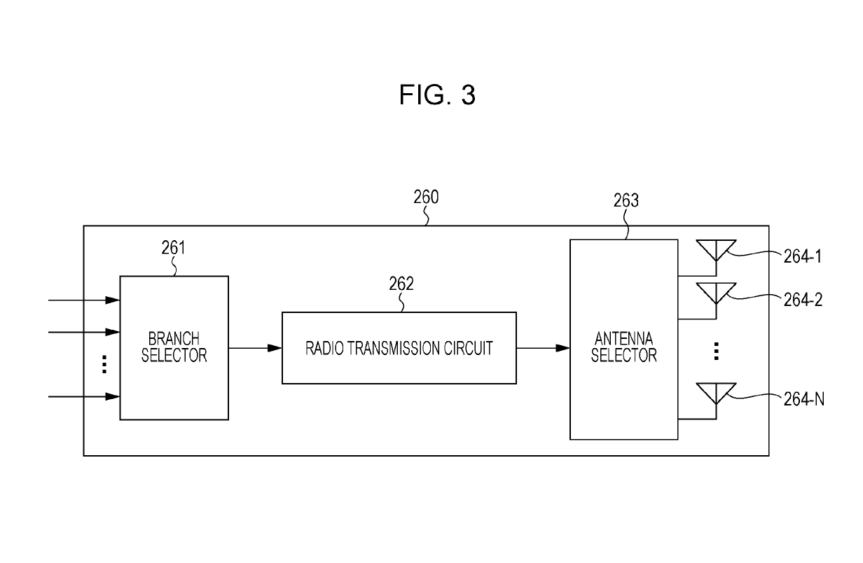

FIG. 3 illustrates an example of a configuration of the radio transmitter 260.

As illustrated in FIG. 3, the radio transmitter 260 includes a branch selector unit 261, the radio transmission circuit 262, and an antenna selector unit 263.

The branch selector unit 261 selects a signal of corresponding one of the transmission branches from among the signals of the N branches, which are output from the frequency shifter 250, at each timing of transmitting a code sequence of each transmission branch.

The radio transmission circuit 262 performs signal processing for the radio transmission, that is, the upconversion and amplification on the signal of the single branch, which is output from the branch selector unit 261.

The antenna selector unit 263 transmits the radio signal of the single branch, which is output from the radio transmission circuit 262, from each transmission antenna 264 included in the first to N-th transmission antennas 264-1 to 264-N, depending on the transmission timing. A frequency spectrum of the radar signal is described in detail below.

A configuration of the radar receiver 300 in FIG. 1 is described. The radar receiver 300 includes a radio receiver 310, a correlator 320, a coherent adder 330, a Doppler analyzer 340, and an arrival direction estimator 350. The correlator 320, the coherent adder 330, and the Doppler analyzer 340 correspond to an echo signal processor according to the present disclosure.

The radio receiver 310 receives an echo signal in each of first to M-th reception branches using for example, the M reception antennas, which are not illustrated. The echo signal is the signal that the target (object) reflects the radar signal transmitted from the radar transmitter 200. After that, the radio receiver 310 outputs a reception signal, which is obtained through the conversion of the received echo signal from the radio frequency band into the baseband. The frequency fc of the local oscillation signal used in the conversion of the received echo signal from the radio frequency band into the baseband is identical among the first to M-th reception branches. The reception signals that correspond to the first to M-th reception branches are first to M-th reception signals, respectively.

The correlator 320 uses the code sequences that the orthogonal encoder 230 has used in coding signals of the first to N-th transmission branches as correlation coefficients for the first to M-th reception signals output from the radio receiver 310 and computes cross correlation.

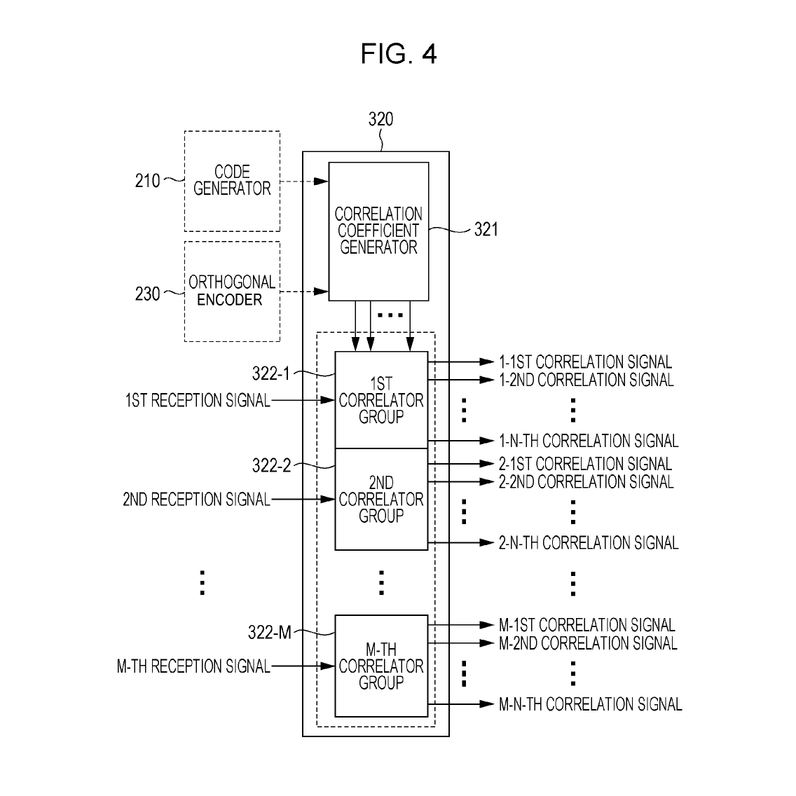

FIG. 4 illustrates an example of a configuration of the correlator 320.

As illustrated in FIG. 4, the correlator 320 includes a correlation coefficient generator 321 and first to M-th correlator groups 322-1 to 322-M.

The codes output from the code generator 210 and the code sequences used by the orthogonal encoder 230 for the orthogonal coding are input to the correlation coefficient generator 321, and the correlation coefficient generator 321 determines the correlation coefficients for the first to M-th reception signals. For example, the code output from the code generator 210 in a given transmission repetition period is c(n,t), and an orthogonal code bit superimposed by the orthogonal encoder 230 is oc(n,t). The correlation coefficient generator 321 outputs a value calculated by multiplying c(n,t) by oc(n,t) as the correlation coefficient. That is, the correlation coefficient generator 321 outputs the first to N-th correlation coefficients that correspond to the first to N-th transmission branches in each given transmission repetition period.

The first to M-th reception signals are input to the first to M-th correlator groups 322-1 to 322-M. The m-th reception signal output from the radio receiver 310 is input to the m-th correlator group 322-m, where m represents a given integer between 1 and M inclusive. The N correlation coefficients output from the correlation coefficient generator 321 are input to the m-th correlator group 322-m, and the m-th correlator group 322-m computes the correlation between the m-th reception signal and each of the N correlation coefficients.

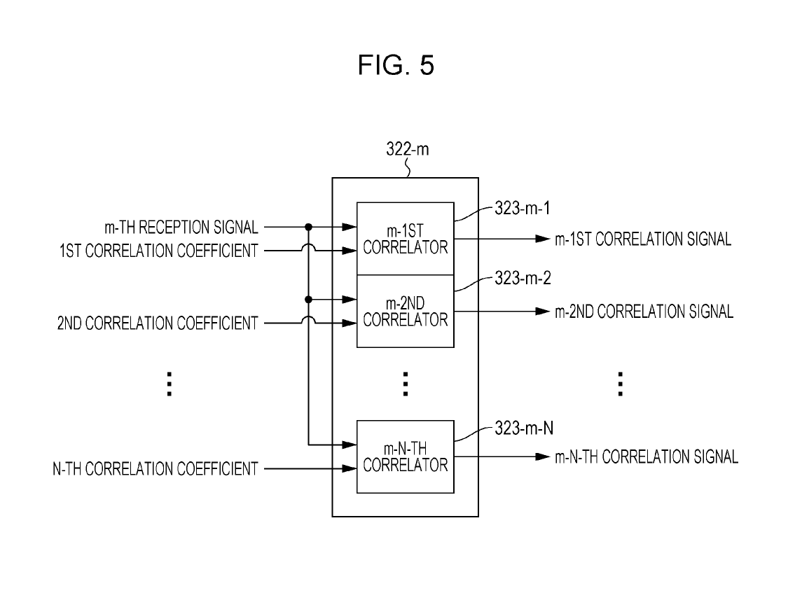

FIG. 5 illustrates an example of a configuration of the m-th correlator group 322-m.

As illustrated in FIG. 5, the m-th correlator group 322-m includes m−1st to m−N-th correlators 323-m−1 to 323-m−N, which correspond to the first to N-th transmission branches. The m-th reception signal and corresponding one of the first to N-th correlation coefficients are input to each correlator 323-m, and the correlator 323-m computes cross correlation and outputs a correlation signal. That is, the m-th correlator group 322-m estimates a signal propagation path between each of the first to N-th transmission branches and the m-th reception branch.

That is, the correlator 320 in FIG. 1 outputs correlation signals of M×N branches so as to compute cross correlation to the first to N-th transmission branches for the respective first to M-th reception branches.

The coherent adder 330 performs coherent addition computation for each of the correlation signals of the M×N branches input from the correlator 320 so as to increase a reception signal-to-noise ratio (SNR). The coherent addition computation is a process of extracting components corresponding to the transmission intervals, that is, the transmission repetition periods of the pulse compression codes from the correlation signals and performing the addition repeatedly at certain timings. Since the pulse compression codes are repeatedly transmitted at certain time intervals as described above, correlation outputs that correspond to the certain intervals are extracted and added.

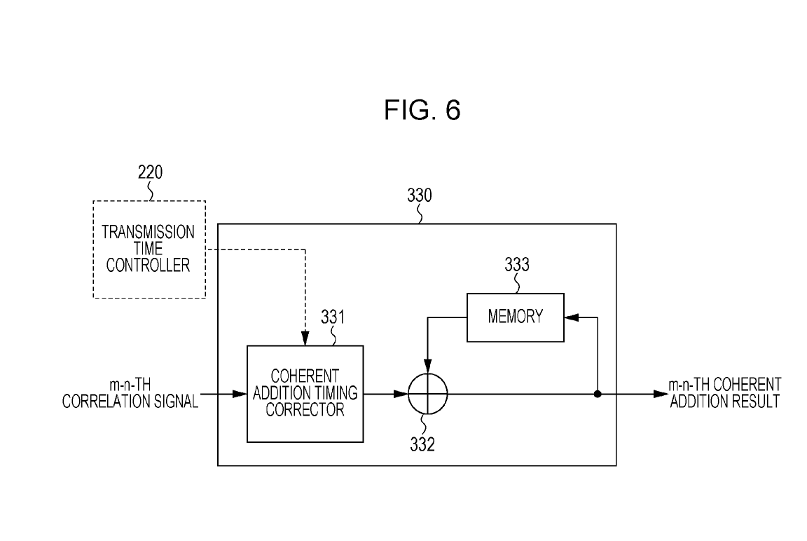

FIG. 6 illustrates an example of a configuration of the coherent adder 330. In the coherent adder 330, M×N blocks, one of which is illustrated in FIG. 6, are arranged so as to correspond to the correlation signals of the M×N branches. The block related to the m−n-th correlation signal, where n represents a given integer between 1 and N inclusive, is illustrated and described.

As illustrated in FIG. 6, the coherent adder 330 includes a coherent addition timing corrector 331, an adder 332, and memory 333.

The coherent addition timing corrector 331 determines a reference timing of the coherent addition in accordance with the transmission timings controlled by the transmission time controller 220 of the radar transmitter 200. The coherent addition timing corrector 331 outputs the m−n-th correlation signal, which is the correlation signal regarding the combination of the m-th reception branch and the n-th transmission branch to the subsequent stage at the determined timing.

A cumulative addition circuit that includes the adder 332 and the memory 333 performs cumulative addition on the outputs from the coherent addition timing corrector 331 and outputs the m−n-th coherent addition result.

The coherent adder 330 extracts the correlation signals in respective transmission repetition periods Ts on the basis of the reference timing and adds Nca parts of the extracted signals. When the number of times of performing the coherent addition for the extracted correlation signals is Nca, the period during which the transmission repetition period Ts is repeated for the Nca times is defined as a coherent addition period Tca.

The coherent adder 330 outputs the coherent addition results of the M×N branches. The coherent addition is described in detail below.

The Doppler analyzer 340 analyzes a Doppler frequency for the coherent addition result input from the coherent adder in regard to each of the M×N branches. The frequency band of the echo signal, that is, the reflected wave from the target that moves involves a Doppler frequency shift. Thus, the Doppler analyzer 340 uses a Fourier transform to analyze the Doppler frequency.

The Doppler analyzer 340 performs the Fourier transform per distance step from the radar device 100 to the target and outputs a distance-Doppler map. The distance-Doppler map is two-dimensional data, where for example, the horizontal axis indicates a Doppler frequency and the vertical axis indicates a distance. The distance step ΔR is determined by Expression 1 below using a reception digital sampling rate fs. In Expression 1, c represents the velocity of light.

[Mathematical Expression 1]

ΔR=c/(2×fs) (1)

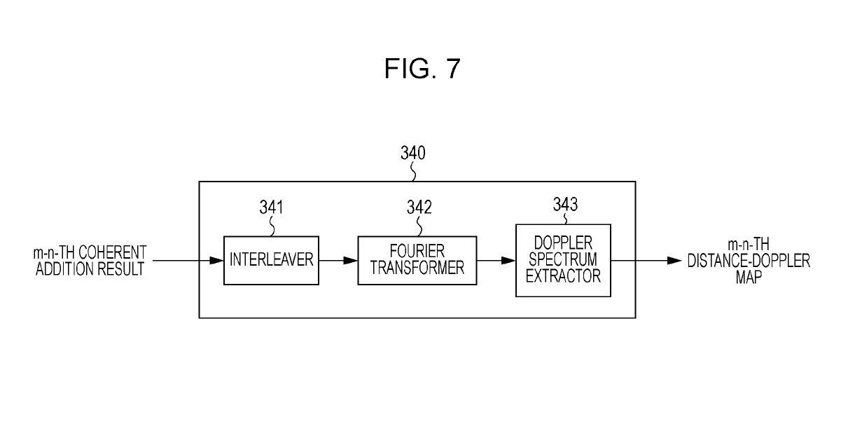

FIG. 7 illustrates part of a configuration of the Doppler analyzer 340. In the Doppler analyzer 340, M×N blocks, one of which is illustrated in FIG. 7, are arranged so as to correspond to the coherent addition results of the M×N branches. The block related to the m−n-th coherent addition result is illustrated and described.

As illustrated in FIG. 7, the Doppler analyzer 340 includes an interleaver 341, a Fourier transformer 342, and a Doppler spectrum extractor 343.

The interleaver 341 interleaves the m−n-th coherent addition result. The Fourier transformer 342 performs the Fourier transform on the interleaved m−n-th coherent addition result and outputs the distance-Doppler map. The Doppler spectrum extractor 343 extracts part corresponding to a desired Doppler frequency from the distance-Doppler map, which is a Doppler spectrum. The interleave, the Fourier transform, and the Doppler spectrum extraction are described in detail below.

The Doppler analyzer 340 as a whole outputs the distance-Doppler maps of the M×N branches.

The arrival direction estimator 350 in FIG. 1 estimates an arrival direction from the radar device 100 to the target using the distance-Doppler maps of the M×N branches input from the Doppler analyzer 340. The arrival direction estimator 350 outputs a distance-angle-Doppler map, which may be also referred to as a distance-arrival-direction-Doppler map. Capon's method or a multiple signal classification (MUSIC) algorithm may be employed as a scheme for the arrival direction estimation.

The respective “distance-Doppler maps” of the M×N branches are data obtained from combinations of the N transmission antennas and the M reception antennas. Accordingly, phase components different from one another are included among the “distance-Doppler maps” corresponding to the branches that differ. The arrival direction estimator 350 determines a phase difference based on the different phase components and estimates the arrival direction.

The transmission time control, the orthogonal coding, the frequency shift amount, the frequency spectrum of a radar signal, the reference timing of the coherent addition, the interleave, and the Doppler spectrum extraction are described in detail below.

### [Transmission Time Control]

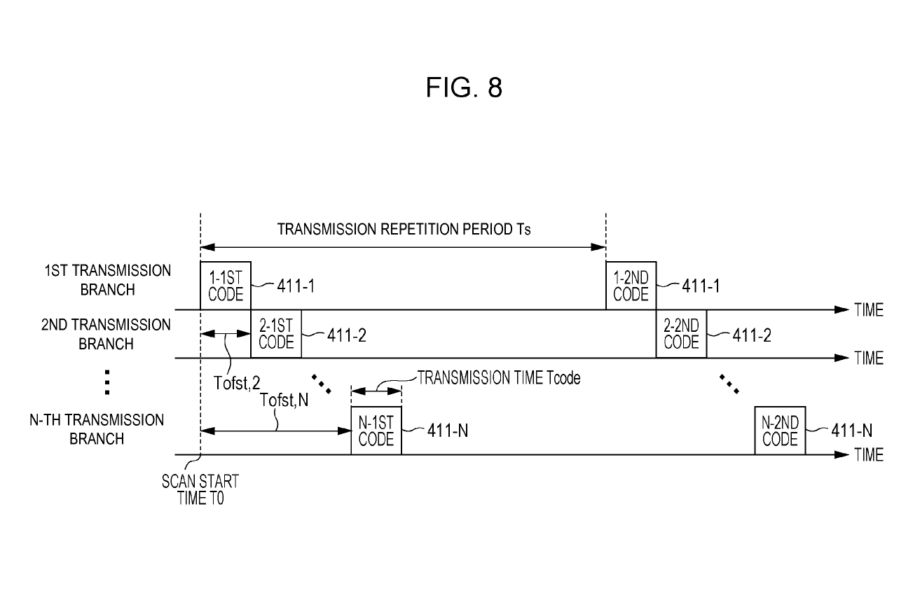

FIG. 8 illustrates an example of the transmission time control process performed by the transmission time controller 220. As illustrated in FIG. 8, the horizontal axis indicates time.

The code generator 210 outputs code sequences 411-1 to 411-N of the first to N-th transmission branches in cycles at certain time intervals. The repeated period is defined as the transmission repetition period Ts, which corresponds to the above-described certain interval. The time needed for the transmission of each code 411 output from each transmission branch is referred to as transmission time Tcode. The time from scan start time TO of the n-th transmission branch is referred to as a transmission timing offset amount Tofst,n.

The transmission time controller 220 sets the respective transmission timings of the codes, which each have the unique transmission timing offset amount Tofst,n different from transmission branch to transmission branch, that is, of the codes whose transmission start timings are shifted among the first to N-th transmission branches. The transmission time controller 220 sets a value that causes the time equal to the transmission timing offset amount Tofst,n plus the transmission time Tcode to be less than the transmission repetition period Ts as the transmission timing offset amount Tofst,n.

The radar device 100 disperses signals to be transmitted in terms of time and can reduce a peak-to-average power ratio, which is hereinafter referred to as the “PAPR.”

Peak power that can be output without distortion has an upper limit. Accordingly, a conventional radar device needs reduction in average power when the PAPR is large. Thus, the large PAPR causes decrease in an average reception SNR. The radar device 100 according to the present disclosure can raise average power relatively because of the reduction in the PAPR and increase an average reception SNR. Due to the reduction in the PAPR, the radar device 100 can narrow a dynamic range necessary on the reception side and simplify the device.

Further, the transmission time controller 220 desirably sets the transmission timing of each of the codes as illustrated in FIG. 8 so as to avoid overlapping of the transmission time periods occupied by the first to N-th transmission branches. The radar device 100 in FIG. 8 may reduce the PAPR by the largest amount.

### [Orthogonal Coding]

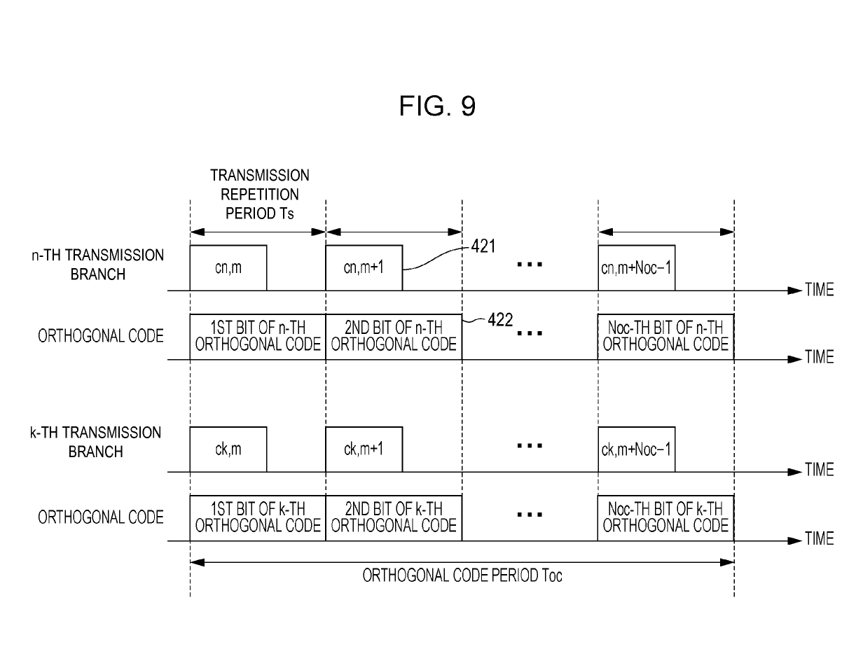

FIG. 9 illustrates an example of the orthogonal coding process in the orthogonal encoder 230. In FIG. 9, the horizontal axis indicates time.

For example, the orthogonal encoder 230 uses a Noc-bit orthogonal code, that is, an orthogonal code with bits, the number of which is Noc. The time that corresponds to the Noc bits of the orthogonal code is defined as an orthogonal code period Toc. The orthogonal encoder 230 switches first to Noc-th bits 422 of an orthogonal code sequentially by one bit in each transmission repetition period Ts and superimposes the first to Noc-th bits 422 on each code sequence 421, which corresponds to the code sequence 411 in FIG. 8.

A case where Noc=2, that is, two-bit orthogonal codes are used, and m=1 is described below as a concrete example. Here [+1,+1] and [+1,−1] are orthogonal codes orthogonal to each other. An orthogonal code where n=[+1,−1] is superimposed on a first code sequence (cn,1) and a second code sequence (cn,2) of the n-th transmission branch. Further, an orthogonal code where k=[+1,+1] is superimposed on a first code sequence (ck,1) and a second code sequence (ck,2) of the k-th transmission branch where k represents a given integer between 1 and N inclusive.

In regard to the n-th transmission branch, the orthogonal encoder 230 generates an orthogonal code by multiplying the code sequence (cn,1) by +1 in the first transmission repetition period Ts and generates another orthogonal code by multiplying the code sequence (cn,2) by −1 in the subsequent transmission repetition period Ts.

In regard to the k-th transmission branch, the orthogonal encoder 230 generates an orthogonal code by multiplying the code sequence (ck,1) by +1 in the first transmission repetition period Ts and generates another orthogonalized code by multiplying the code sequence (ck,2) by +1 in the subsequent transmission repetition period Ts.

The code sequence generated by the code generator 210 in each transmission repetition period Ts of each transmission branch is constituted of a plurality of bit strings. For example, the code sequence (cn,1)=[+1, +1,−1, +1] and the code sequence (cn,2)=[+1, +1, +1, −1]. The orthogonalized code (ck,1) multiplied by +1 and the orthogonalized code (ck,2) multiplied by −1, which are generated by the orthogonal encoder 230 for the n-th transmission branch, are expressed by Expressions 2 and 3 below.

[Mathematical Expression 2]

(cn,1)×(+1)=[+1,+1,−1,+1] (2)

[Mathematical Expression 3]

(cn,2)×(−1)=[−1,−1,−1,+1] (3)

The orthogonal encoder 230 superimposes any one of the plurality of bits that constitute the orthogonal codes on all the code sequences of the first to N-th transmission branches, that is, multiplies all the code sequences of the first to N-th transmission branches by any one of the plurality of bits that constitute the orthogonal codes in each transmission repetition period Ts.

Further, the orthogonal encoder 230 switches the bit to be used, which is included the plurality of bits that constitute the orthogonal code, and superimposes the switched bit on the code sequences, that is, multiplies the code sequences by the switched bit in each transmission repetition period Ts. The orthogonal encoder 230 superimposes an identical value on the code sequences in one transmission repetition period Ts. Although the polarities of the whole of the code sequences vary between + and −, the correlation among the polarities of the constituent bits in the transmission repetition period Ts remains unchanged. The radar device 100 can hold a cross correlation performance among the code sequences used for each transmission branch.

An m-sequence or a Gold code is a code favorable in the cross correlation performance and a sequence where mutual interference among the transmission branches is hard to occur. The radar device 100 can suppress mutual interference among the signals transmitted from the first to N-th transmission branches by holding the cross correlation performance among the code sequences.

In addition, as a result of the coherent addition, the radar device 100 can compensate for mutual interference components among the first to N-th transmission branches by superimposing the orthogonal codes. The code generator 210 may output the identical code sequences or may output different code sequences in the orthogonal code period Toc.

For example, in the above-described example of the two-bit orthogonal codes, the results obtained through the cross correlation between the sequence (cn,1) multiplied by +1 and the sequence (cn,2) multiplied by (−1) are (Cn,1)×(+1) and (Cn,2)×(−1), respectively. When (Cn,1)=(Cn,2), the coherent addition result indicates that (Cn,1)×(+1)+(Cn,2)×(−1)=0. That is, the radar device 100 may compensate for the mutual interference components among the transmission branches. The code generator 210 may generate a complementary code as the pulse compression code.

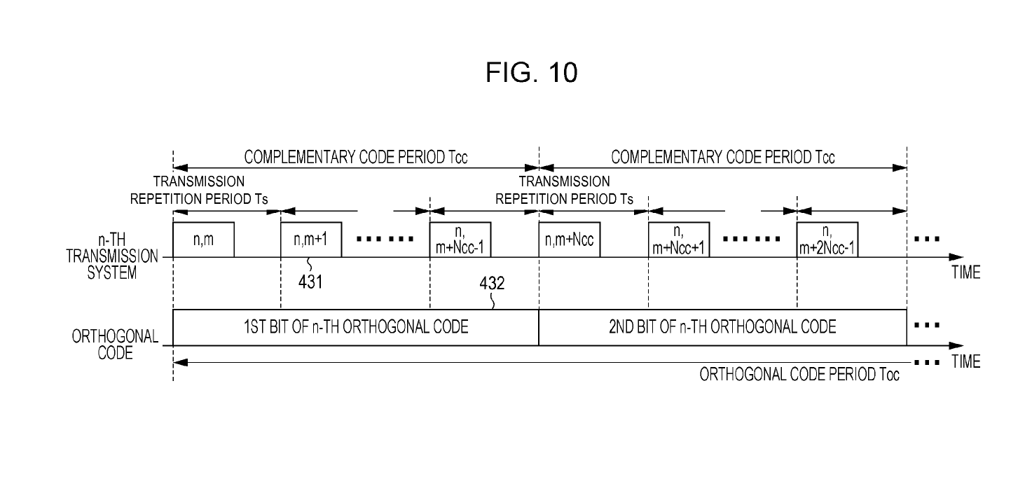

FIG. 10 illustrates an example of the orthogonal coding process, where the pulse compression code is a complementary code. As illustrated in FIG. 10, the horizontal axis indicates time.

A code sequence 431 before superimposing of an orthogonal code is a complementary code. The complementary code is constituted of Ncc codes. The transmission time controller 220 outputs each of the Ncc complementary codes to the orthogonal encoder 230 in each transmission repetition period Ts. The period in which the Ncc complementary codes are output is defined as a complementary code period Tcc. That is, the complementary code period Tcc=the transmission repetition period Ts×Ncc, where Ncc represents the number of complementary codes.

When the pulse compression code is a complementary code, the orthogonal encoder 230 performs the switching of the bit 432 of the orthogonal code illustrated in FIG. 10 in each complementary code period Tcc.

In regard to the complementary code, although a range side lobe component does not become zero, depending on autocorrelation of each of the codes that constitute the complementary code, the range side lobe component becomes zero by performing the coherent addition on all the autocorrelation results of the complementary code. Accordingly, the orthogonal code can be superimposed while holding a range side lobe suppression effect of the complementary code by switching the bit of the orthogonal code in each complementary code period Tcc.

Similar to what is described with reference to FIG. 9, the code generator 210 desirably outputs a combination of identical complementary codes in the orthogonal code period Toc. Thus, as a result of the coherent addition, the radar device 100 may compensate for mutual interference components among the transmission branches.

### [Frequency Shift Amount]

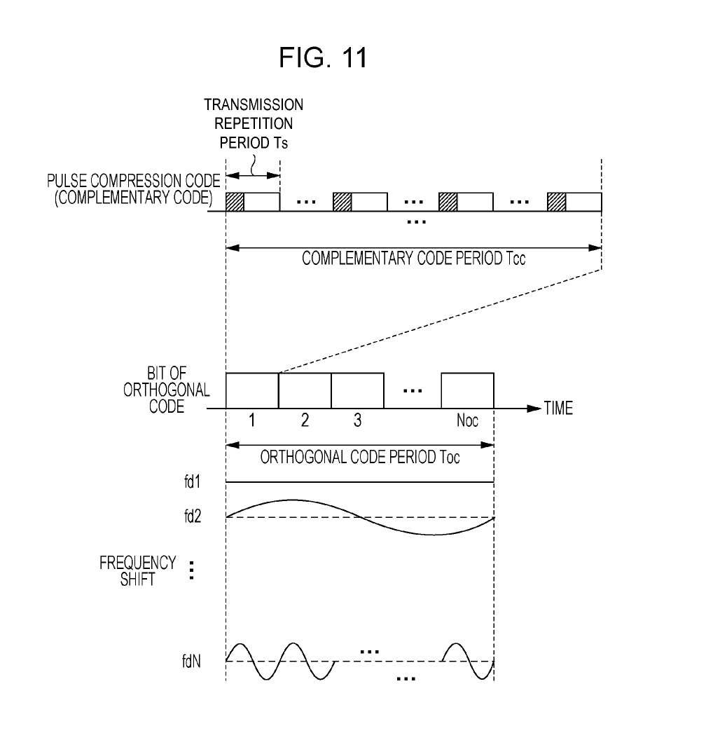

FIG. 11 illustrates an example of the frequency shift process performed by the frequency shifter 250. The frequency shifter 250 has frequency shift amounts to be provided to the respective modulation signals of the first to N-th transmission branches in advance.

A frequency foc that corresponds to the orthogonal code period Toc is defined by Expression 4 below.

[Mathematical Expression 4]

foc=1/Toc (4)

The frequency shift amount fdn provided to the n-th transmission branch is expressed by for example, Expression 5 below.

[Mathematical Expression 5]

fdn=x(n)×foc (5)

In Expression 5, x(n) represents an integer different from transmission branch to transmission branch. The frequency shifter 250 provides the frequency shifts to the respective modulation signals of the transmission branches, and the frequency shift is an integral multiple of the frequency corresponding to the orthogonal code period Toc included in the modulation signal and differs from transmission branch to transmission branch among the first to N-th transmission branches.

How to determine the frequency shift amount is described. As described above, the coherent adder 330 of the radar receiver 300 performs the coherent addition in each orthogonal code period Toc and decodes the orthogonal code.

For example, an m−n1-th correlation signal am,n1(t) input to the coherent adder 330 can be modeled as in Expression 6 below. In Expression 6, n1 represents a signal (component) of a desired transmission branch.

$$\begin{matrix}[ Mathematical Expression 6 ] & \\ {a}_{m , n 1} ( t ) = {c}_{m , n 1} ( t ) + {\sum }_{\begin{matrix}n = 1 \\ n \neq n 1\end{matrix}}^{N} ( {c}_{m , n} ( t ) exp ( j 2 π ( {f}_{d , n} - {f}_{d , n 1} ) t + {θ}_{n} ) ) & ( 6 )\end{matrix}$$

In Expression 6, cm,n(t) represents a result of performing the correlation computation on the signal transmitted from the n-th transmission branch and received by the m-th reception branch, which is a correlation signal. The correlation signal after the symbol sigma, which is the second element on the right-hand side of Expression 6, indicates an interference component caused by a signal of another transmission branch. That is, Expression 6 includes a residual component of the Doppler frequency shift (fd,n−fd,n1). In Expression 6, t represents time and θ represents a phase difference.

A frequency fca that corresponds to the coherent addition period Tca is defined by Expression 7 below.

[Mathematical Expression 7]

fca=1/Tca (7)

A relation expressed by Expression 8 below holds between the Doppler frequency shift (fd,n−fd,n1) and the frequency fca that corresponds to the coherent addition period Tca.

[Mathematical Expression 8]

(fd,n−fd,n1)=y×fca (8),

where y represents an integer.

The coherent adder 330 performs integral computation on the coherent addition period Tca as an integral period. Accordingly, an output bm,n1(t) of the coherent adder 330 is expressed by for example, Expression 9 below.

$$\begin{matrix}[ Mathematical Expression 9 ] & \\ {b}_{m , n 1} ( t ) = {\int }_{O}^{{T}_{ca}} ( {c}_{m , n 1} ( t ) + {\sum }_{\begin{matrix}n = 1 \\ n \neq n 1\end{matrix}}^{N} ( {c}_{m , n} ( t ) exp ( j 2 π y {f}_{ca} t + {θ}_{n} ) ) ) d t & ( 9 )\end{matrix}$$

According to Expression 7 above, the interference component of the second element on the right-hand side of Expression 9 is caused to approximate zero as illustrated in Expression 10 below.

$$\begin{matrix}[ Mathematical Expression 10 ] & \\ {\int }_{O}^{{T}_{ca}} ( {\sum }_{\begin{matrix}n = 1 \\ n \neq n 1\end{matrix}}^{N} ( {c}_{m , n} ( t ) exp ( j 2 π {yf}_{ca} t + {θ}_{n} ) ) ) d t \approx 0 & ( 10 )\end{matrix}$$

In the radar device 100, when a temporal variation component of cm,n(t) is small, the suppression effect on an interference component is large. The radar device 100 can suppress the interference component by causing the frequency equivalent to an integral multiple of the frequency fca corresponding to the coherent addition period Tca to be the frequency shift amount fdn.

The coherent addition period Tca is an integral multiple of the orthogonal code period Toc. The frequency foc corresponding to the orthogonal code period Toc is an integral multiple of the frequency fca corresponding to the coherent addition period Tca.

The radar device 100 can cause the frequency shift amount fdn to be an integral multiple of the frequency fca corresponding to the coherent addition period Tca by causing the frequency shift amount fdn to be an integral multiple of the frequency foc corresponding to the orthogonal code period Toc, and can bring the above-described advantages.

For example, as illustrated in FIG. 11, the first to N-th frequency shift amounts fd1 to fdN can be obtained by multiplying the frequency foc corresponding to the orthogonal code period Toc by 0, 1, 2, . . . N−1.

In a conventional radar device, the orthogonality of an orthogonal code is decreased by providing a frequency shift to a code on which an orthogonal code is superimposed. In contrast, the radar device 100 can bring the suppression effect on an interference component by causing the frequency shift amount to be an integral multiple of the frequency foc corresponding to the orthogonal code period Toc.

The first to N-th frequency shift amounts fd1 to fdN are frequencies smaller than a maximum Doppler frequency observable in the radar receiver 300.

The maximum Doppler frequency observable in the radar receiver 300, Fdmax, is expressed by Expression 11 below using the number of times of repeating the transmission, which is represented as Ts in Expression 11, and the number of times of performing the coherent addition, which is represented as Nca in Expression 11.

[Mathematical Expression 11]

Fdmax=1/{2×(Ts×Nca)} (11)

Expression 11 corresponds to a Nyquist frequency when a coherent addition period Nca is a sample period of the Fourier transform.

When the antennas are arranged near one another and there is no large difference among the directivities of the antennas, the Doppler shift that occurs between each antenna and the target causes no large unevenness. The radar device 100 desirably divides a usable Doppler frequency band, that is, a band to the maximum Doppler frequency Fdmax, equally, and sets the frequency shift amounts with equal intervals.

For example, the n-th frequency shift fdn provided to the n-th transmission branch is desirably (n−1) times as much as the frequency obtained by dividing the maximum Doppler frequency Fdmax by N as expressed in Expression 12 below.

[Mathematical Expression 12]

fdn=Fdmax×(n−1)/N (12)

The first to N-th frequency shifts fd1 to fdN provided by the transmission side are each observed as the Doppler shifts on the reception side. Since the first to N-th frequency shifts fd1 to fdN are known, the Doppler shift based on each frequency shift can be observed apart from the Doppler shift caused by a speed component of the target.

### [Frequency Spectrum of Radar Signal]

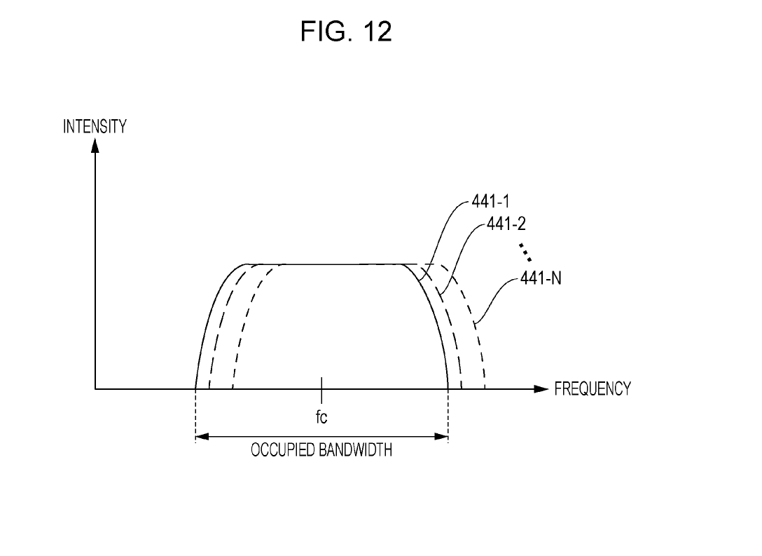

FIG. 12 illustrates an example of the frequency spectrum of each radar signal output from the radio transmitter 260. In FIG. 12, the horizontal axis indicates a frequency and the vertical axis indicates the intensity of each frequency component.

As described above, the first to N-th frequency shift amounts fd1 to fdN provided by the frequency shifter 250 are frequency shifts smaller than the occupied bandwidth. Thus, as illustrated in FIG. 12, frequency spectra 441-1 to 441-N of the respective radar signals output from the first to N-th transmission branches overlap around the frequency fc of the local oscillation signal.

### [Coherent Addition]

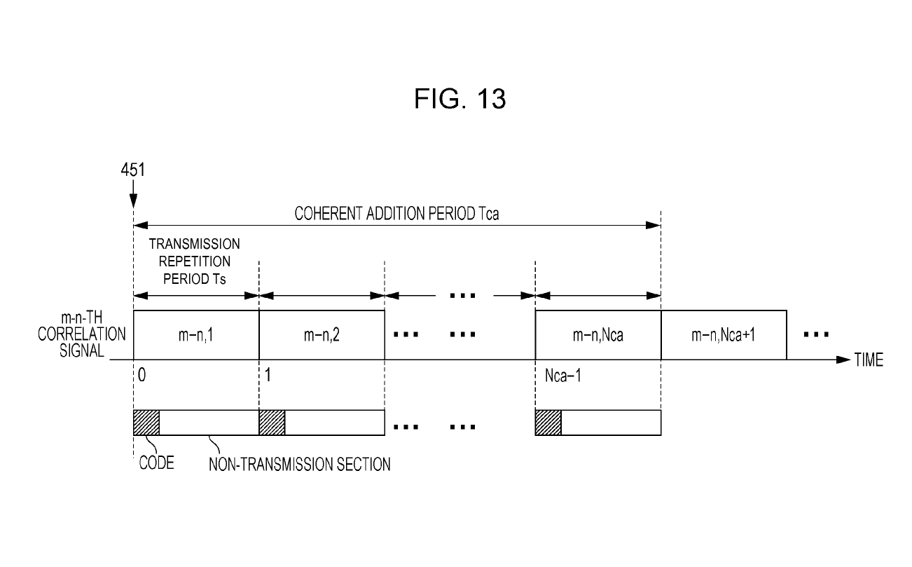

FIG. 13 illustrates an example of a reference timing of the coherent addition performed in the coherent adder 330.

As illustrated in FIG. 13, the coherent addition timing corrector 331 of the coherent adder 330 sets a timing at which the signal transmitted from the n-th transmission branch is input to the radar receiver 300 with no delay, that is, a timing at which the distance to the target amounts to zero, as a reference timing 451. After that, the coherent addition timing corrector 331 extracts the m−n-th correlation signal in each transmission repetition period Ts on the basis of the reference timing 451.

The number of times of performing the coherent addition of the coherent adder 330 on the extracted m−n-th correlation signal is Nca as described above. The coherent addition period Tca equals the transmission repetition period Ts multiplied by the number of times of performing the coherent addition, or specifically Nca.

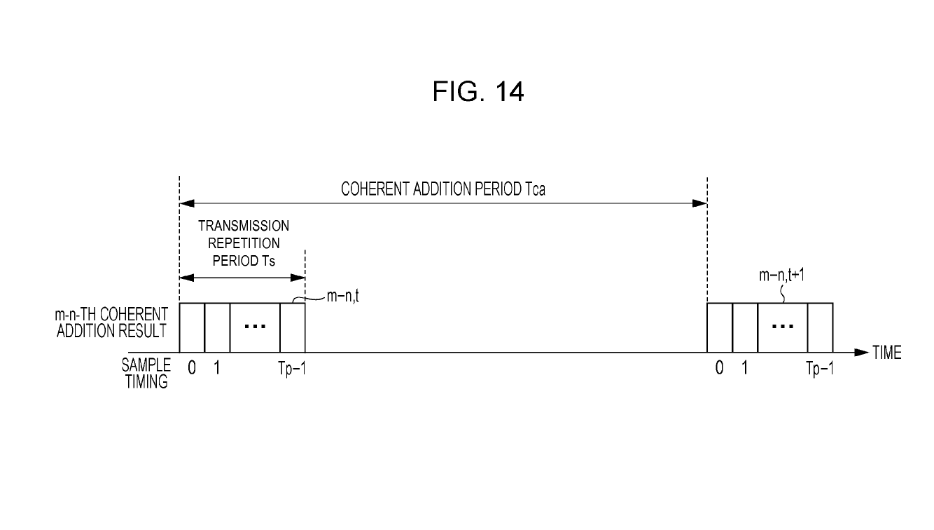

FIG. 14 illustrates a timing at which the coherent adder 330 outputs a coherent addition result.

As illustrated in FIG. 14, the coherent adder 330 outputs the coherent addition result of the m−n-th correlation signal in each coherent addition period Tca. The coherent adder 330 can lower the rate of signal processing at a subsequent stage.

When fs denotes a reception digital sampling rate, the number of sampling a signal in the transmission repetition period Ts, Tp, is a value obtained by multiplying the transmission repetition period Ts by the reception digital sampling rate fs. The sample timings Tm,0 to Tm,p−1 of the coherent addition result in the transmission repetition period Ts are illustrated in FIG. 14.

The sample timings Tm,0 to Tm,p−1 are also referred to as range bins and each correspond to the distance from the radar device 100 to the target. Data on each sample timing can be converted into information on the distance to the target.

### [Interleave]

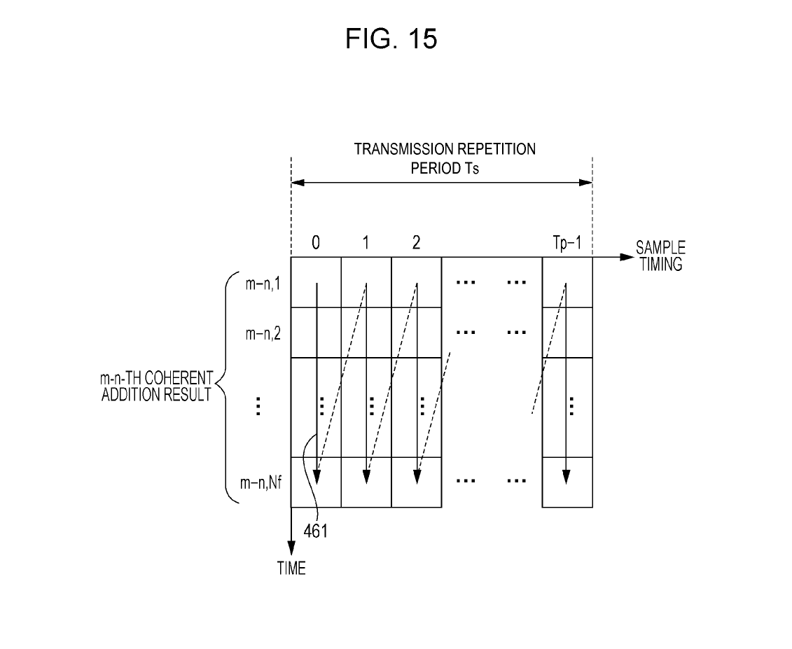

FIG. 15 illustrates an example of the interleave process in the Doppler analyzer 340. In FIG. 15, the horizontal axis indicates a sample timing and the vertical axis indicates time.

As illustrated in FIG. 15, the interleaver 341 of the Doppler analyzer 340 sorts the coherent addition result (see FIG. 14) into two-dimensional data with axes that indicate the sample timings Tm,0 to Tm,p−1 and the time described above, respectively. After that, the interleaver 341 reads the sorted data in the order indicated by arrows 461.

The interleaver 341 sorts the data on consecutive Nf transmission repetition periods Ts into data consolidated according to each sample timing based on the starting point of each transmission repetition period Ts.

### [Fourier Transform]

The Fourier transformer 342 of the Doppler analyzer 340 converts the time-base variation in the sorted data onto the Doppler frequency axis. The Fourier transformer 342 converts the time waveform into the spectrum of the Doppler frequency, that is, the Doppler spectrum.

When the coherent addition period Tca serves as the sample period of the Fourier transform and Ndp denotes the number of sample points of the Fourier transform, the number of sample points Ndp that is obtained when the transmission repetition period Ts×the number of times of performing the coherent addition, or Nca, × the Fourier transform is defined as a Doppler analysis period Tdp.

As described above, the sample timing of the Fourier transform can be converted into the distance from the radar device 100 to the target. That is, the data consolidated according to each sample timing is data consolidated according to each range, which is the distance to the target.

Thus, the above-described sort enables the temporal variation in the coherent addition result dependent on the distance to be observed. That is, the output of the Fourier transformer 342 is two-dimensional data of the distance and the Doppler frequency. The two-dimensional data of the distance and the Doppler frequency is defined as the distance-Doppler map.

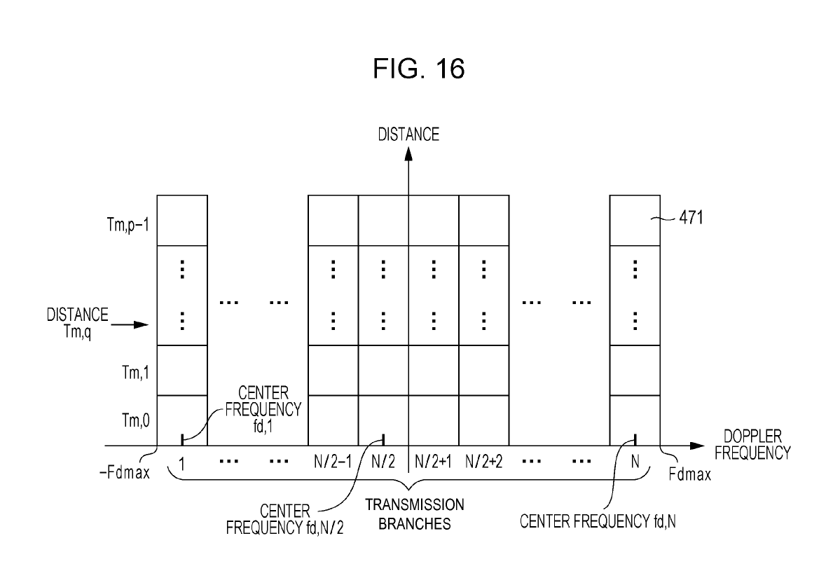

FIG. 16 illustrates an example of a data configuration of the distance-Doppler map.

As described above, the first to N-th radar signals transmitted from the first to N-th transmission branches undergo the frequency shifts using the frequency shift amounts fd1 to fdN different from one another.

As illustrated in FIG. 16, the distance-Doppler map is separatable on the basis of each combination of the first to N-th transmission branches and distances (ranges) Tm,0 to Tm,p−1, which is illustrated as a rectangle 471 in FIG. 16, and is data that indicates the Doppler frequency component. That is, according to the distance-Doppler map, the first to N-th radar signals undergo division multiplexing on the Doppler frequency axis such that the first to N-th radar signals can be separated. The distance-Doppler map includes data on the distance Tm,p where the target is present.

### [Doppler Spectrum Extraction]

The Doppler spectrum extractor 343 of the Doppler analyzer 340 extracts part that corresponds to a desired Doppler frequency from the distance-Doppler map input from the Fourier transformer 342 on a distance-by-distance basis.

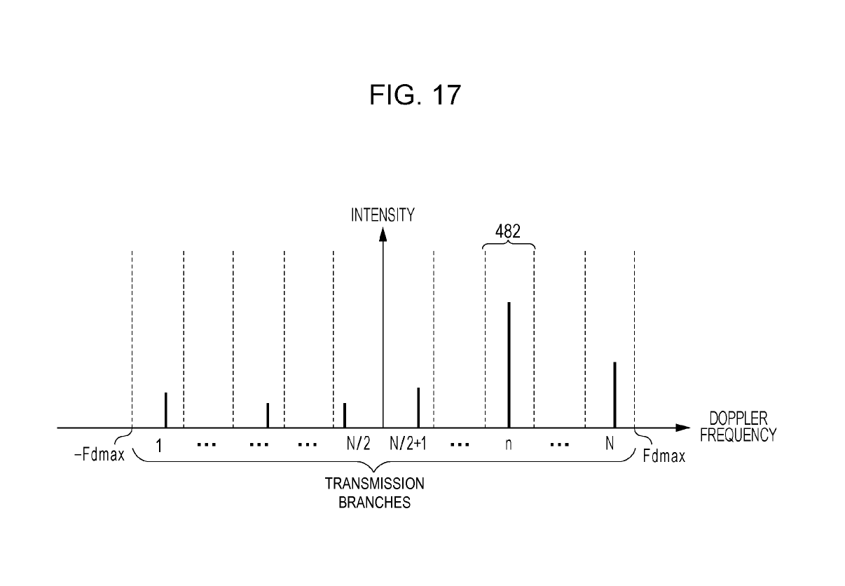

FIG. 17 illustrates an example of the Doppler analysis result, which is the Doppler spectrum, regarding the distance Tm,p in which the target of a certain correlation signal is present. In FIG. 17, the horizontal axis indicates the Doppler frequency and the vertical axis indicates the intensity of each Doppler frequency component.

As illustrated in FIG. 17, the distance-Doppler map (see FIG. 16) output from the Fourier transformer 342 is separatable on the basis of each transmission branch and indicates the intensity of each Doppler frequency component. Accordingly, the Doppler spectrum extractor 343 that corresponds to the n-th transmission branch can extract the Doppler component of the n-th transmission branch by extracting part 482 corresponding to the n-th transmission branch, which is included in the distance-Doppler map.

The Doppler spectrum extractor 343 associates each extracted Doppler frequency component of the distance-Doppler map with the Doppler frequency where the frequency shift is omitted. That is, the Doppler spectrum extractor 343 shifts the extracted Doppler frequency axis of the distance-Doppler map by −fdn.

The radar device 100 performs the frequency shift on respective signals of the transmission branches using the frequency shift amounts, which are integral multiples of the frequency foc corresponding to the orthogonal code period Toc, that is, integral multiples of the frequency corresponding to the coherent addition period Tca and differ from transmission branch to transmission branch. The radar device 100 can extract a Doppler frequency analyze result corresponding to each frequency shift amount for each reception signal while the interference components among the transmission branches are reduced through the coherent addition, and detect the target.

### [Operation of Radar Device]

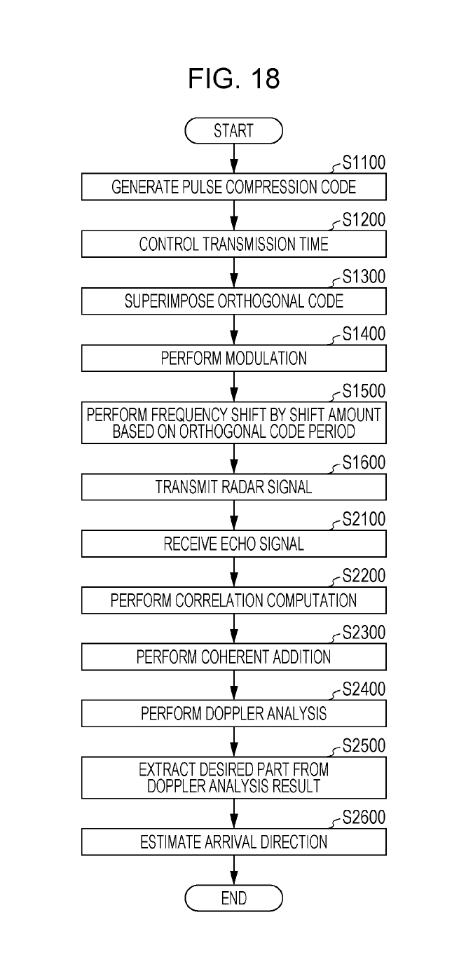

Operation of the radar device 100 is now described. FIG. 18 illustrates an example of the operation of the radar device 100. The present example indicates the operation that the radar device 100 sequentially performs for one pulse compression code.

In step S1100, the code generator 210 generates a pulse compression code related to the n-th transmission branch.

In step S1200, the transmission time controller 220 controls the time when the generated pulse compression code is transmitted from the radar transmitter 200.

In step S1300, the orthogonal encoder 230 superimposes one of the constituent bits of the n-th orthogonal code on the pulse compression code.

In step S1400, the modulator 240 modulates the pulse compression code on which the orthogonal code is superimposed.

In step S1500, the frequency shifter 250 provides the frequency shift to the modulation signal using the frequency shift amount fdn determined on the basis of the orthogonal code period Toc. As described above, the frequency shift amount fdn is the frequency that is obtained by multiplying the frequency foc corresponding to the orthogonal code period Toc by an integer differing from transmission branch to transmission branch and is smaller than the maximum Doppler frequency Fdmax.

In step S1600, the radio transmitter 260 converts the modulation signal provided with the frequency shift into a radio signal and transmits the radio signal as a radar signal.

The transmitted radar signal is reflected by the target and received as an echo signal.

In step S2100, the radio receiver 310 receives the respective echo signals in the first to M-th reception branches.

In step S2200, the correlator 320 computes cross correlation while the code sequences used in the orthogonal encoder 230 serve as correlation coefficients.

In step S2300, the coherent adder 330 performs the coherent addition on correlation signals. Since a difference from another transmission branch in the frequency shift amount is an integral multiple, the coherent addition reduces interference components caused by the other transmission branch as described above.

In step S2400, the Doppler analyzer 340 performs the Doppler analysis on the coherent addition result.

In step S2500, the Doppler analyzer 340 extracts part that is desired and corresponds to the n-th transmission branch from the Doppler analysis result on the basis of the frequency shift amount fdn.

The arrival direction estimator 350 estimates an arrival direction, that is, a direction of the target on the basis of the respective Doppler analysis results extracted for the first to N-th transmission branches including the n-th transmission branch.

### Advantages of Present Embodiment

As described above, the radar device 100 according to the present embodiment provides an signal of each transmission branch with the frequency shift fdn, which is an integral multiple of the frequency foc corresponding to the orthogonal code period Toc and differs from transmission branch to transmission branch.

Thus, the radar device 100 extracts the respective Doppler frequency analyze results for the transmission branches while the interference components among the transmission branches are reduced, and detects the target. That is, the radar device 100 can perform the target detection with the higher accuracy than that performed by the conventional techniques.

### [Another Example of Frequency Shift Amount]

Although in the description above, the frequency shift amount fdn is a frequency that is an integral multiple of the frequency foc corresponding to the orthogonal code period Toc, the frequency shift amount fdn is not limited thereto. The radar device 100 may use a frequency that is unlikely to decrease the orthogonalities of the signals transmitted from the first to N-th transmission branches, such as an orthogonal frequency, and may use the frequency shift amounts different from transmission branch to transmission branch.

Examples of the orthogonal frequency includes a frequency, which is an integral multiple of the frequency shift amount fdn, the coherent addition period Tca, the Doppler analysis period Tdp, or the complementary code period Tcode.

FIG. 19 illustrates an example of the frequency shift process based on the coherent addition period Tca.

The frequency shift amount fdn provided to the n-th transmission branch is expressed by Expression 13 below using for example, the frequency fca corresponding to the coherent addition period Tca.

[Mathematical Expression 13]

fdn=x(n)×foc (13)

As illustrated in FIG. 19, the first to N-th frequency shift amounts fd1 to fdN are frequencies obtained by multiplying the frequency fca corresponding to the coherent addition period Tca by 0, 1, 2, . . . N−1.

The frequency shift process illustrated in FIG. 19 can suppress the interference components according to the principle described using Expression 10.

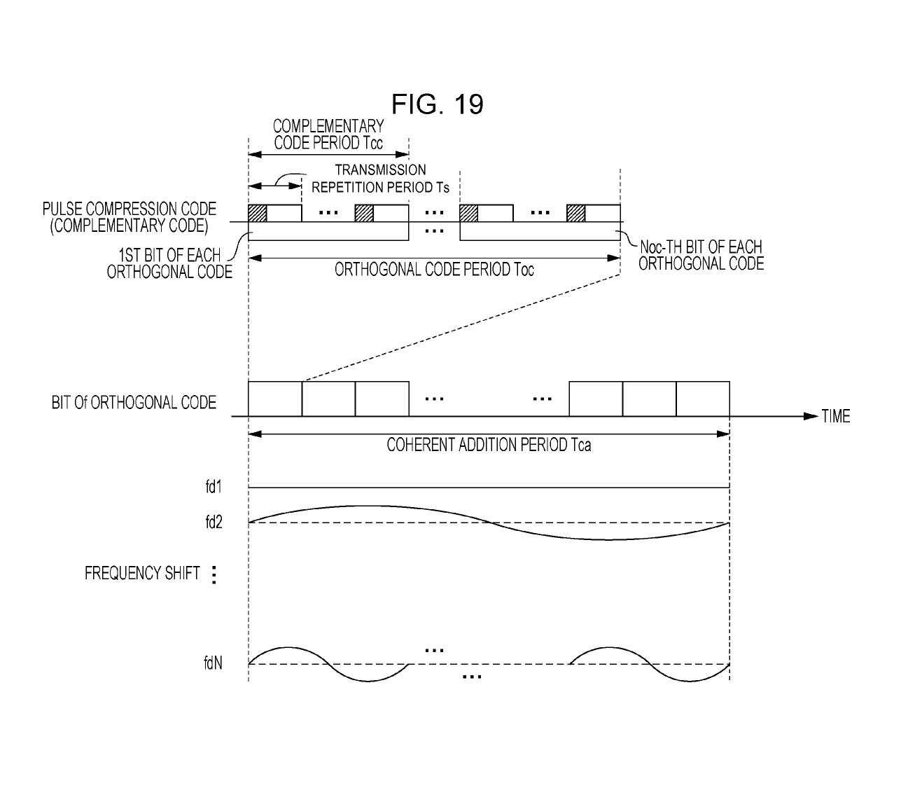

FIG. 20 illustrates an example of the frequency shift process based on the Doppler analysis period Tdp.

The frequency shift amount fdn provided to the n-th transmission branch is expressed by Expression 14 below using for example, the Doppler analysis period Tdp and an integer x(n) that differs from transmission branch to transmission branch.

[Mathematical Expression 14]

fdn=x(n)/Tdp (14)

The frequency shift amount fdn is a frequency that is an integral multiple of the period corresponding to the Doppler analysis period Tdp. The frequency shift amount fdn is an orthogonal frequency in the Fourier transformer 342.

To cause the frequency shift amount fdn to be a value smaller than the maximum Doppler frequency Fdmax observable in the radar receiver 300, the integer x(n) needs to satisfy Expression 15 below on the basis of the number of sample points Ndp of the Fourier transform.

[Mathematical Expression 15]

x(n)<Ndp/2 (15)

The mutual interference among the signals of the first to N-th transmission branches, which undergo multiplexing on the Doppler frequency axis, can be minimized by causing the frequency shift amount fdn to serve as the orthogonal frequency in the Fourier transformer 342.

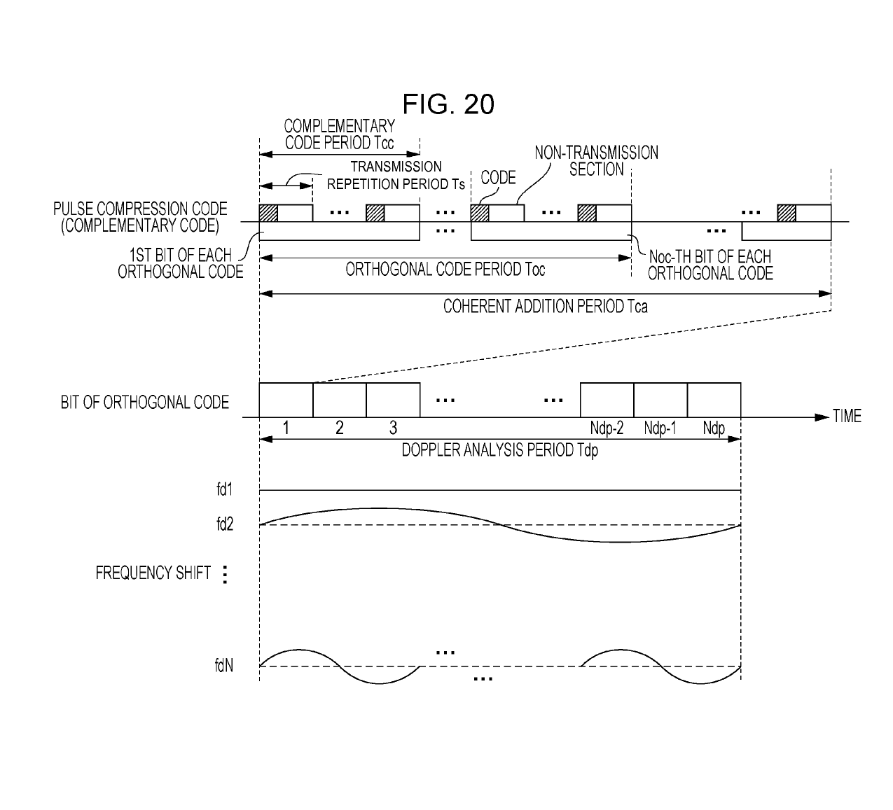

FIG. 21 illustrates an example of the frequency shift process based on the complementary code period Tcc.

The frequency fcc that corresponds to the complementary code period Tcc is defined by Expression 16 below.

[Mathematical Expression 16]

fcc=1/Tcc (16)

The frequency shift amount fdn provided to the n-th transmission branch is expressed by Expression 17 below using for example, the frequency fcc, which corresponds to the complementary code period Tcc, and the integer x(n), which differs from transmission branch to transmission branch.

[Mathematical Expression 17]

fdn=x(n)/Tcc (17)

The orthogonal code period Toc is an integral multiple of the complementary code period Tcc as can be seen in FIG. 11. The frequency shift process illustrated in FIG. 20 can suppress the interference components according to the principle described using Expression 10 above.

### [Another Example of Frequency Shift]

Although the method of multiplying a modulation signal by a signal with consecutive waveforms, which has the frequency shift amount fdn, is used for the frequency shift process in the description above, the frequency shift process is not limited to this method.

The frequency shifter 250 may perform the frequency shift by multiplying the modulation signal by the discretized frequency shift component.

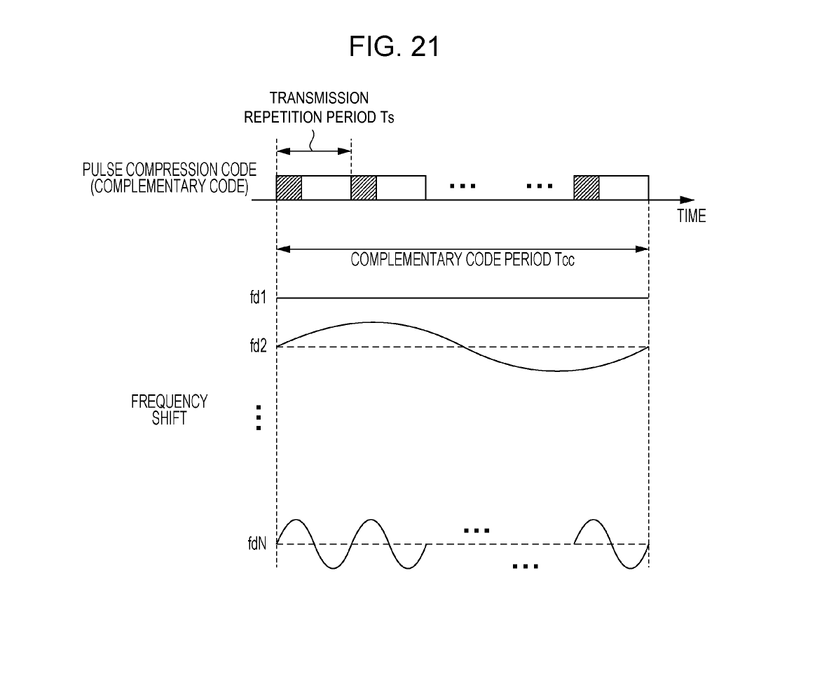

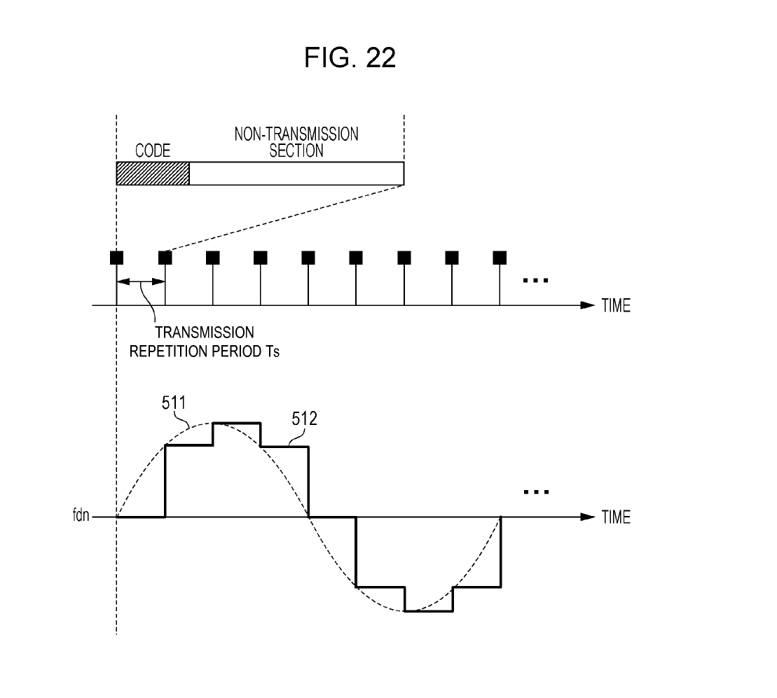

FIG. 22 illustrates an example of the frequency shift component discretized on the basis of each transmission repetition period Ts.

As illustrated in FIG. 22, for example, the frequency shifter 250 samples a signal 511 with the frequency of the frequency shift amount fdn according to the transmission repetition period Ts and multiplies the modulation signal by a value 512 obtained through the sampling as the discretized frequency shift amount fdn.

The radar device 100 observes temporal variation in the sample signal at each sample timing in the transmission repetition period Ts illustrated in FIG. 14, that is, variation in the sample signal among the plurality of consecutive coherent addition periods Tca. Accordingly, a plurality of channels can undergo the multiplexing on the Doppler frequency axis by observing the temporal variation in the frequency shift component in each coherent addition period Tca.

Since the transmission repetition period Ts is smaller than the coherent addition period Tca, as illustrated in FIG. 22, the temporal variation in the frequency shift component can be observed even when the discretized frequency shift amount fdn is employed.

In a conventional radar device, the cross correlation performance of a code is lowered when a frequency shift, which is a signal with consecutive waveforms, is superimposed on a modulation signal.

In contrast, when the discretized frequency shift component illustrated in FIG. 22 is superimposed on a modulation signal, decrease in the cross correlation performance of a code can be suppressed and a plurality of channels can undergo multiplexing on the Doppler frequency axis. The present embodiment is favorable for use of a code with a high cross correlation performance, such as an m-sequence or a Gold code. In addition, the discretization illustrated in FIG. 22 is applicable to all of the frequency shift amount providing methods illustrated in FIGS. 11, 19, 20, and 21.

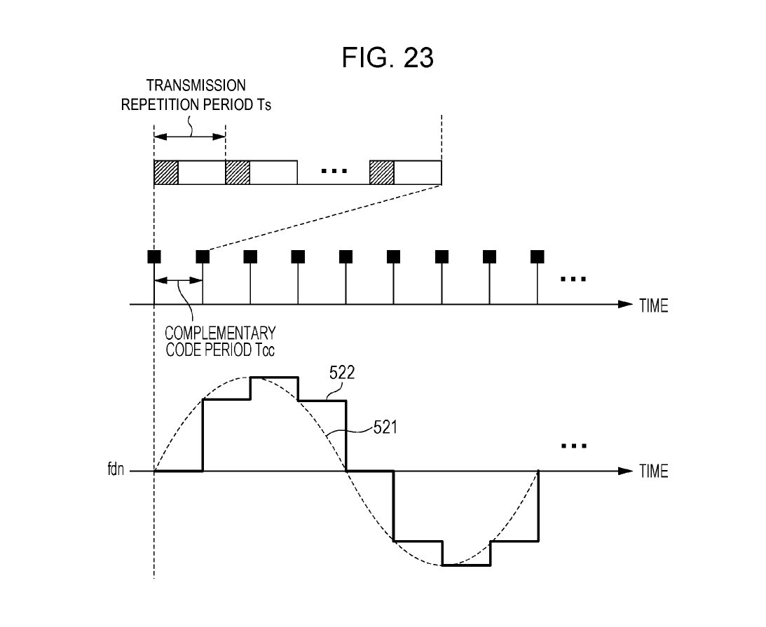

FIG. 23 illustrates an example of the frequency shift component discretized according to the complementary code period Tcc.

As illustrated in FIG. 23, for example, the frequency shifter 250 samples a signal 521 with the frequency of the frequency shift amount fdn according to the complementary code period Tcc and multiplies the modulation signal by a value 522 obtained through the sampling as the discretized frequency shift amount fdn.

In a conventional radar device, when a complementary code is used for a radar signal and a frequency shift of consecutive waveforms is superimposed in the complementary code period Tcc, the range side lobe suppression performance brought by adding autocorrelation results of the complementary code is decreased.

As illustrated in FIG. 23, the radar device 100 can suppress decrease in the high autocorrelation performance that a complementary code has, and enables a plurality of channels to undergo multiplexing on the Doppler frequency axis by superimposing a discretized frequency shift component on a modulation signal. In addition, the discretization illustrated in FIG. 23 is applicable to the frequency shift amount providing methods illustrated in FIGS. 11, 19, and 20.

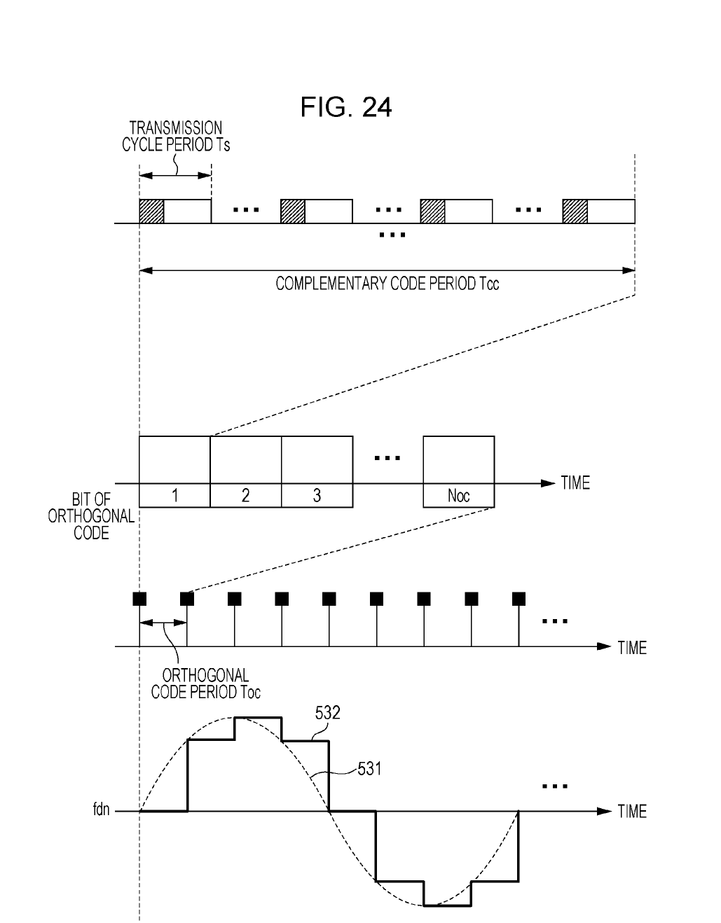

FIG. 24 illustrates an example of the frequency shift component discretized according to the orthogonal code period Toc.

As illustrated in FIG. 24, for example, the frequency shifter 250 samples a signal 531 with the frequency of the frequency shift amount fdn according to the orthogonal code period Toc and multiplies the modulation signal by a value 532 obtained through the sampling as the discretized frequency shift amount fdn.

In a conventional radar device, when an orthogonal code is used for a radar signal, the orthogonal performance of the orthogonal code is decreased by superimposing a frequency shift with consecutive waveforms in the orthogonal code period Toc.

As illustrated in FIG. 24, the radar device 100 can suppress decrease in the orthogonal performance that the orthogonal code has, and enables a plurality of channels to undergo multiplexing on the Doppler frequency axis by superimposing the discretized frequency shift component on a modulation signal. In addition, the discretization illustrated in FIG. 24 is applicable to the frequency shift amount providing methods illustrated in FIGS. 19 and 20.

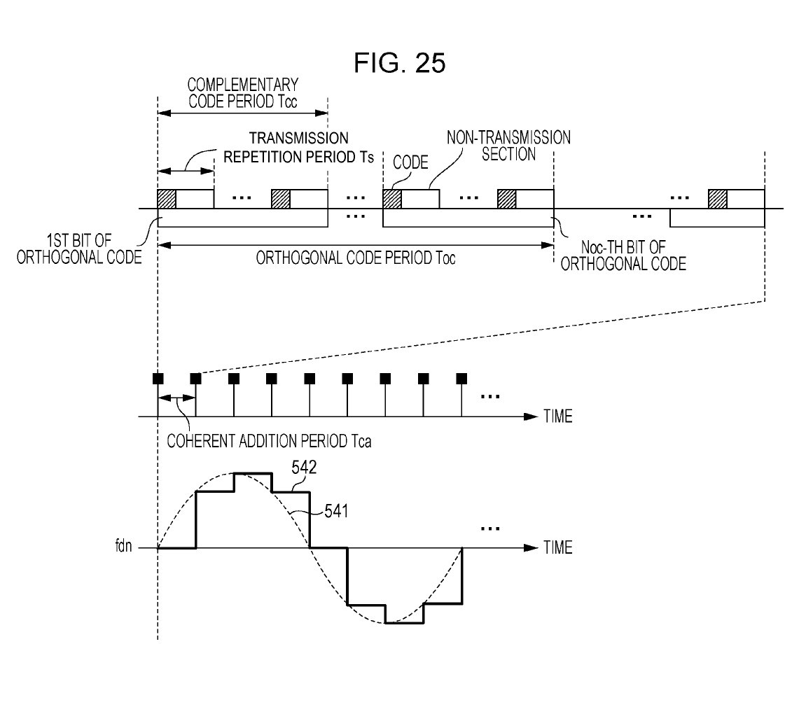

FIG. 25 illustrates an example of the discretized frequency shift component according to the coherent addition period Tca.

As illustrated in FIG. 25, for example, the frequency shifter 250 samples a signal 541 with the frequency of the frequency shift amount fdn according to the coherent addition period Tca and multiplies the modulation signal by a value 542 obtained through the sampling as the discretized frequency shift amount fdn.

The coherent addition period Tca is a period of an integral multiple of all of the complementary code period Tcc and the orthogonal code period Toc. The radar device 100 can suppress decrease in the characteristics of the code used, such as the autocorrelation performance, the cross correlation performance, or the orthogonality, and enables a plurality of channels to undergo multiplexing on the Doppler frequency axis. Discretizing the frequency shift component on the basis of the coherent addition period Tca is useful to perform the multiplexing on a plurality of channels on the Doppler frequency axis. The discretization illustrated in FIG. 25 is applicable to the frequency shift amount providing method illustrated in FIG. 20.

### [Another Example of Signal Separation]

Although the separation of the Doppler components for each transmission branch is performed in the Doppler analyzer 340 in the description above, the separation is not limited thereto. The radar device 100 may separate the Doppler components for each transmission branch prior to for example, the correlation computation.

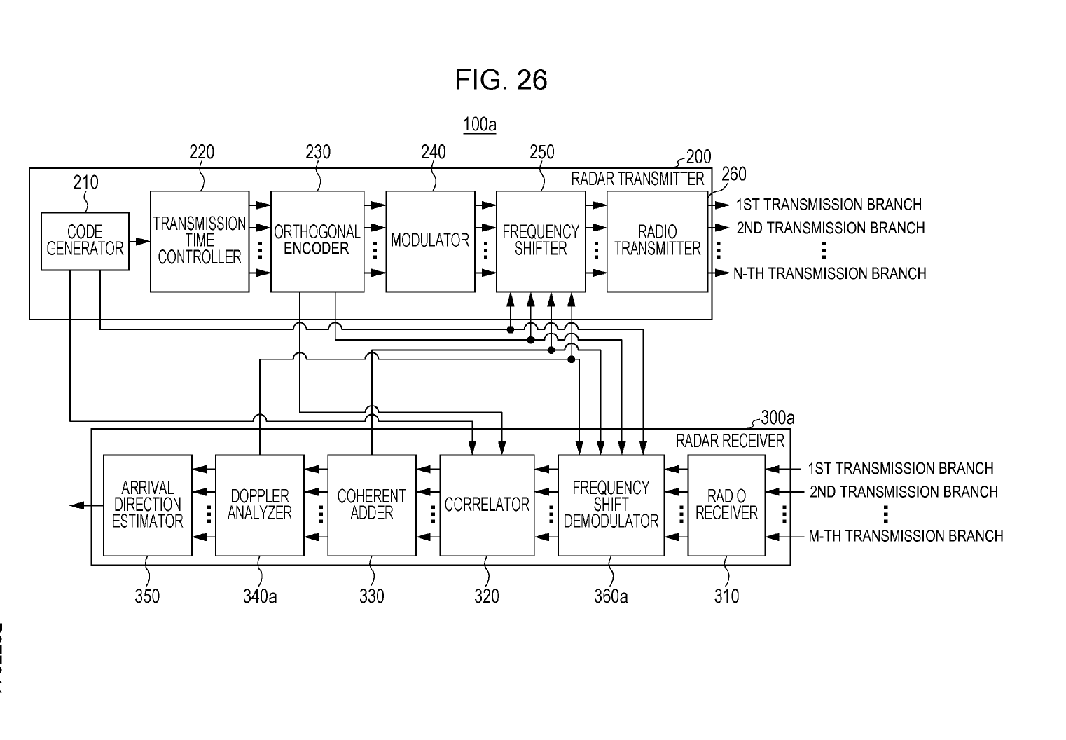

FIG. 26 illustrates an example of a configuration of a radar device 100a, which separates the Doppler components for each transmission branch prior to the correlation computation, and corresponds to FIG. 1. The same references are given to the elements the same as those in FIG. 1 and the explanation on such elements is omitted.

As illustrated in FIG. 26, a radar receiver 300a of the radar device 100a includes a frequency shift demodulator 360a arranged at the preceding stage of the correlator 320. The radar receiver 300a further includes a Doppler analyzer 340a instead of the Doppler analyzer 340 in FIG. 1.

In the radar device 100a, the frequency shift demodulator 360a demodulates the frequency shift provided by the radar transmitter 200 and the coherent adder 330 performs the coherent addition. The demodulation and the coherent addition correspond to the process of downconverting the signal that has been upconverted in the frequency shifter 250 in the frequency shift demodulator 360a and the process of causing the resultant signal to pass through a low-pass filter in the coherent adder 330.

The frequency shift demodulator 360a demodulates the frequency shift provided in the frequency shifter 250 of the radar transmitter 200.

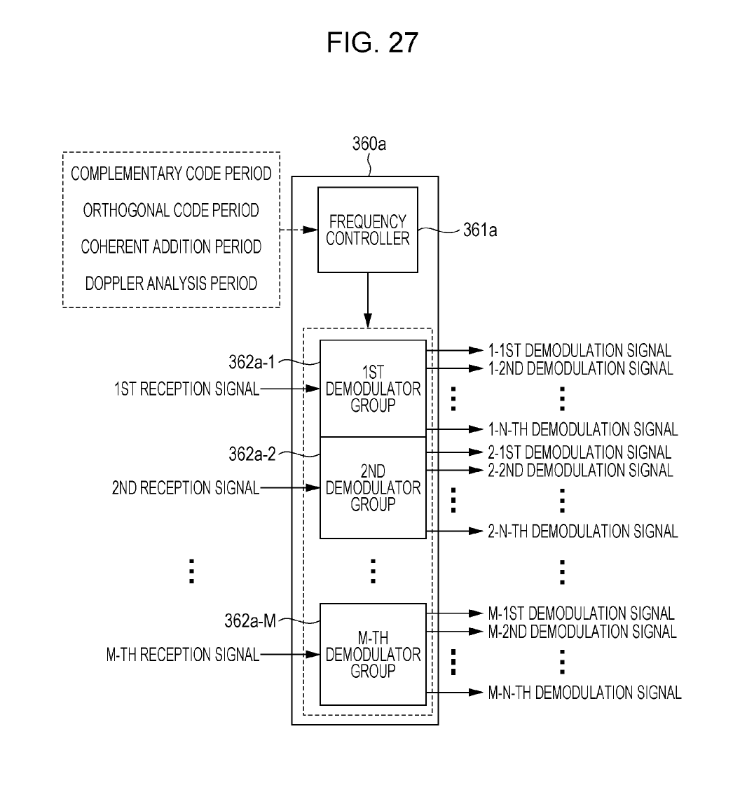

FIG. 27 illustrates an example of a configuration of the frequency shift demodulator 360a.

As illustrated in FIG. 27, the frequency shift demodulator 360a includes a frequency controller 361a, and first to M-th demodulator groups 362a-1 to 362a-M that correspond to the first to M-th reception branches.

In the frequency shift demodulator 360a, values −fd1 to −fdN are preset as first to N-th frequency shift demodulation amounts that are identical in absolute value and opposite in polarity to the first to N-th frequency shift amounts set in the frequency controller 251 of the frequency shifter 250 (see FIG. 2).

The frequency controller 361a of the frequency shift demodulator 360a outputs N demodulation signals corresponding to the first to N-th frequency shift demodulation amounts −fd1 to −fdN to each of the first to M-th demodulator groups 362a-1 to 362a-M.

First to M-th reception signals are input to the first to M-th demodulator groups 362a-1 to 362a-M. The m-th reception signal output from the radio receiver 310 is input to the m-th demodulator group 362a-m. The m-th demodulator group 362a-m generates N demodulation signals on the basis of the m-th reception signal and the N demodulation signals input from the frequency controller 361a. That is, the frequency shift demodulator 360a outputs demodulation signals of M×N branches.

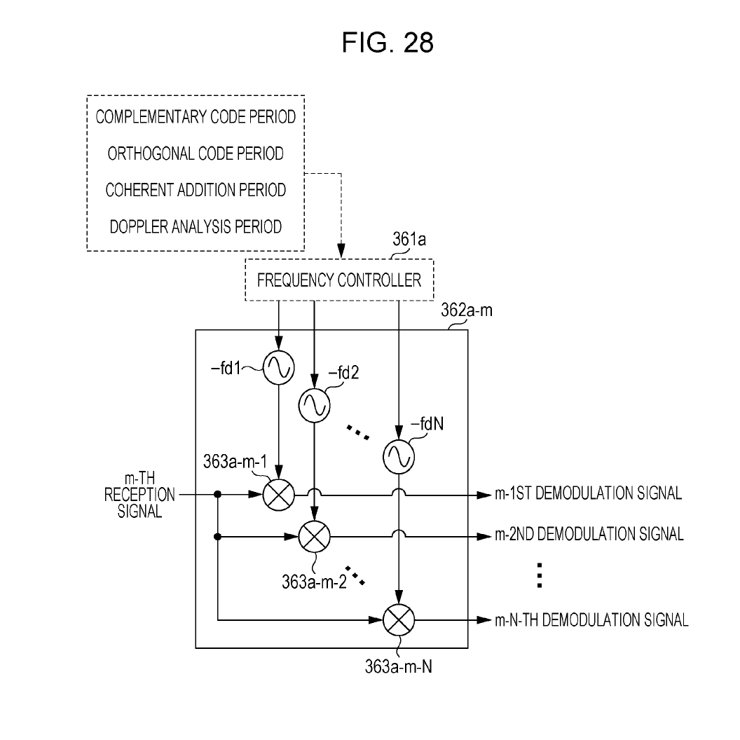

FIG. 28 illustrates an example of a configuration of the m-th demodulator group 362a-m.

As illustrated in FIG. 28, the m-th demodulator group 362a-m includes m−1st to m−N-th multipliers 363a-m−1 to 363a-m−N that correspond to the first to N-th transmission branches. The m-th reception signal and the demodulation signal of the n-th frequency shift demodulation amount −fdn are input to the m−n-th multiplier 363a-m−n. That is, the m−n-th multiplier 363a-m−n adds the n-th frequency shift demodulation amount −fdn to the m-th reception signal and outputs the resultant signal as the m−n-th demodulation signal.

The output m−n-th demodulation signal is input to the m−n-th correlator 323-m−n in the correlator 320 (see FIG. 4).

The Doppler analyzer 340a in FIG. 26 has a configuration identical to that of the Doppler analyzer 340 in FIG. 1 except that the band extracted from the distance-Doppler map in the Doppler spectrum extractor 343 (see FIG. 7) is different.

When the frequency shift of a reception signal is demodulated in advance, the Doppler spectra extracted concentrate near direct current (DC).

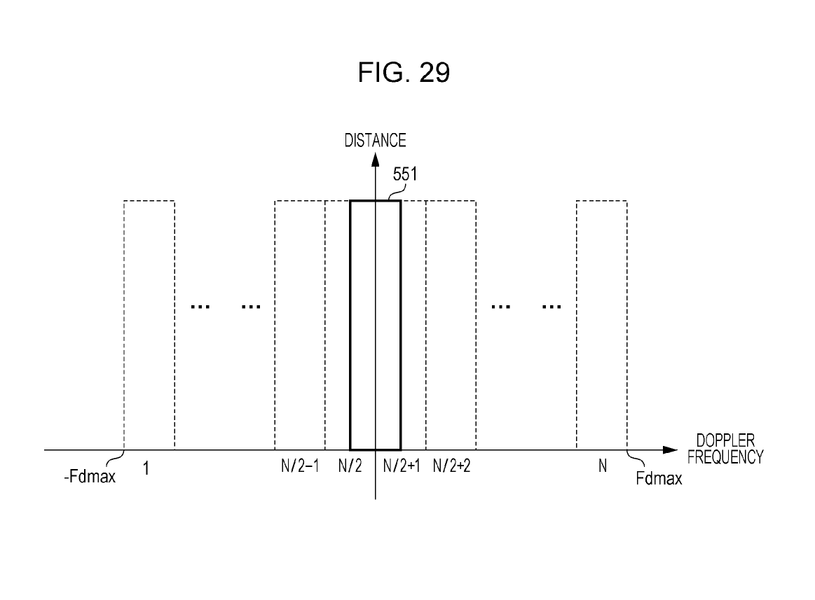

FIG. 29 illustrates an example of a data configuration of the distance-Doppler map in a case where the frequency shift is demodulated, and corresponds to FIG. 17.

When the frequency shift demodulator 360a demodulates the frequency shift, a desired spectrum extracted moves to a Doppler frequency band 551 near the DC illustrated in FIG. 29 in regard to each transmission branch. Accordingly, the operation of the Doppler analyzer 340a corresponds to the extraction of the Doppler frequency component allocated to the first transmission branch in the radar device 100, which is included in the division and allocation of the Doppler frequencies described using FIG. 17. The operation of the Doppler analyzer 340a is described below.

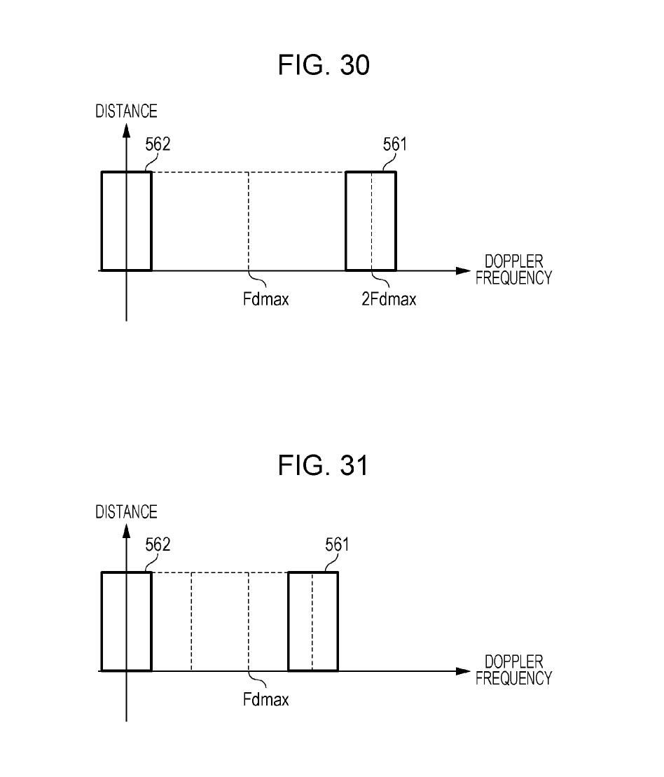

FIG. 30 illustrates an example of the Doppler spectrum. FIG. 31 illustrates an example of the Doppler spectrum after increasing the number of times of performing the coherent addition. In each of FIGS. 30 and 31, the horizontal axis indicates the Doppler frequency and the vertical axis indicates the distance to the target.

In the Doppler spectrum in FIG. 30, an aliasing component 561 is observed at a sample frequency position 2Fdmax dependent on the coherent addition period Tca.

The increase in the number of times of performing the coherent addition lowers the sampling rate of the Doppler analysis. As a result, the aliasing component 561 comes closer to a desired spectrum 562 as illustrated in FIG. 31.

Thus, the number of times of performing the coherent addition may be increased to the sampling rate of the Doppler analysis at which the desired spectrum 562 and an out-of-band spectrum do not interfere. That is, the demodulation using the frequency shift can cause the desired spectrum to concentrate near the DC and can increase the number of times of performing the coherent addition more, compared to a case where the demodulation uses no frequency shift.

The increase in the number of times of performing the coherent addition can reduce load on the subsequent stages caused by the signal processing. That is, the processing load of the Doppler analysis and the processes after the Doppler analysis can be reduced by including the frequency shift demodulator 360a.

The decoded complementary code undergoes the coherent addition in the complementary code period Tcc. Accordingly, similar to the principle described using FIG. 20, the interference components can be reduced by the above-described frequency shift providing method.

### [Another Example of Allocation of Frequency Shift Amount]

Although the frequency shift amount fdn of each transmission branch is fixed in the description above, the frequency shift amount fdn is not limited to the fixed amount. The frequency shifter 250 may switch the frequency shift amount fdn of each transmission branch in each certain period for example.

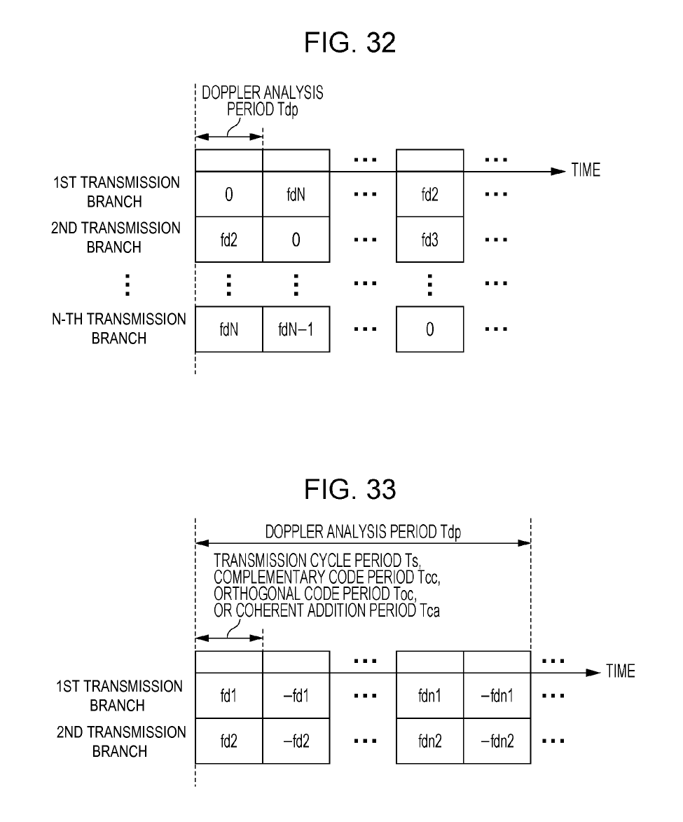

FIG. 32 illustrates an example of the allocation of the frequency shift amount fdn, which is switched for each transmission branch in each Doppler analysis period Tdp. As illustrated in FIG. 32, the horizontal axis indicates time.

As illustrated in FIG. 32, for example, the frequency shifter 250 shifts the frequency shift amounts fd1(0), fd2, . . . , fdN−1, and fdN of N different values in each Doppler analysis period Tdp by one transmission branch and allocates the resultant frequency shift amounts to the first to N-th transmission branches. For example, fd1(0), fdN, fdN−1, . . . , and fd2 are sequentially switched in each Doppler analysis period Tdp and allocated to the first transmission branch.

In the configuration of the radar device 100 illustrated in FIG. 1, the Doppler spectrum extractor 343 of the Doppler analyzer 340 may switch the frequency that is an object to be extracted in synchronization with the switching of the frequency shift amount fdn in the frequency shifter 250.

In the configuration of the radar device 100a illustrated in FIG. 26, the frequency controller 361a of the frequency shift demodulator 360a may switch the frequency of the demodulation signal to be superimposed on each reception signal in synchronization with the switching of the frequency shift amount in the frequency shifter 250. The Doppler spectrum extractor 343 of the Doppler analyzer 340a may extract a spectrum near the DC at the time of the Doppler spectrum extraction.

Further, in the radar device 100a illustrated in FIG. 26, the frequency shift amount fdn of each transmission branch may be switched in each transmission repetition period Ts, each complementary code period Tcc, each orthogonal code period Toc, or each coherent addition period Tca. Since the frequency shift amount fdn differs from transmission branch to transmission branch among the first to N-th transmission branches, mutual interference among the transmission branches can be suppressed.

The radar device according to the present disclosure can change the frequency shift amount fdn used in one transmission branch with time and disperse the influence of quantization noise of the frequency shifter 250. When the frequency shift amount fdn=0, the influence of the quantization noise is the smallest. The frequency shift amount fdn equal to 0 is desirably included in an object of the allocation.

Moreover, in the radar device 100a illustrated in FIG. 26, the polarity of the frequency shift amount, + or −, may be switched in the Doppler analysis period Tdp for each transmission branch.

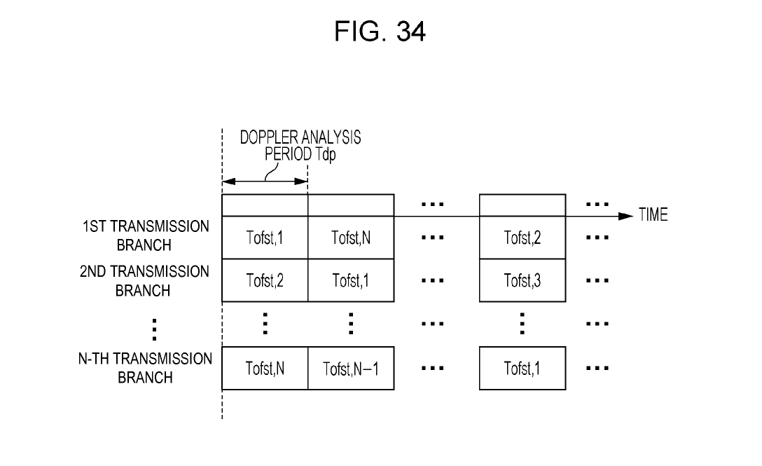

FIG. 33 illustrates an example of the allocation of the frequency shift amounts, where the polarities of the frequency shift amounts of each transmission branch are switched in the Doppler analysis period Tdp. In FIG. 33, the horizontal axis indicates time.

As illustrated in FIG. 33, for example, the frequency shifter 250 alternately switches fdn and −fdn and allocates fdn or −fdn to the n-th transmission branch in each predetermined period. For example, the transmission repetition period Ts, the complementary code period Tcc, the orthogonal code period Toc, or the coherent addition period Tca may be employed as the predetermined period.

In the coherent addition or the Fourier transform, positive (+) components and negative (−) components included in the mutual interference components compensate for each other through the addition by switching the polarities of the frequency shifts according to the periods illustrated in FIG. 33. The radar device according to the present disclosure may compensate for the interference among the transmission branches by switching the frequency shift amounts.

To maximize the effect of the interference compensation, as illustrated in FIG. 33, values identical in absolute value and opposite in polarity are desirably used as the frequency shift amounts by the equal numbers. In addition, since the target moves, times at which frequency shift amounts with polarities opposite each other are provided are desirably arranged more closely in terms of time and desirably arranged in adjacent periods. That is, as illustrated in FIG. 33, fdn and −fdn are desirably allocated to the n-th transmission branch by being alternately switched.

### [Another Example of Transmission Time Control]

Although the transmission timing offset amount Tofst,n of each transmission branch is fixed in the description above, the transmission timing offset amount Tofst,n is not limited to the fixed transmission timing offset amount. For example, the transmission time controller 220 may switch the transmission timing offset amount Tofst,n for each transmission branch in each of certain periods.

FIG. 34 illustrates an example of the allocation of the transmission timing offset amount Tofst,n, where the transmission timing offset amount Tofst,n of each transmission branch is switched in each Doppler analysis period Tdp. In FIG. 34, the horizontal axis indicates time.

As illustrated in FIG. 34, for example, the transmission time controller 220 shifts the transmission timing offset amounts of N different values Tofst,1, Tofst,2, . . . , Tofst,N−1, and Tofst,N by one transmission branch in each Doppler analysis period Tdp and allocates the transmission timing offset amounts to the first to N-th transmission branches. For example, Tofst,1, Tofst,N, Tofst,N−1, . . . , and Tofst,2 are sequentially switched and allocated to the first transmission branch in each Doppler analysis period Tdp.

The coherent addition timing corrector 331 of the coherent adder 330 switches the coherent addition timing in synchronization with the switching of the transmission timing offset amount Tofst,n in the transmission time controller 220.

In a conventional radar device, mutual interference among transmission branches increases through the coherent addition. The radar device according to the present disclosure can disperse the interference components by changing the transmission timing offset amount Tofst,n with time. That is, in regard to a desired wave, the coherent addition can increase the SNR, and in regard to an interference wave component, coherent addition effects can be reduced.

As illustrated in FIG. 34, when the transmission timing offset amount Tofst,n is switched in each Doppler analysis period Tdp, the estimation accuracy of the arrival direction of a desired wave, which is decreased by influence of an interference wave, can be dispersed in each Doppler period. That is, it is possible to obtain, for example, advantages that although in the Doppler analysis period where t=Tdp, the desired wave is buried in interference waves and difficult to be detected, in the Doppler analysis period where t=2×Tdp, temporal positions of the interference waves are shifted and the desired wave may be detected.

The transmission time controller 220 may switch the transmission timing offset amount Tofst,n of each transmission branch in each transmission repetition period Ts, each complementary code period Tcc, each orthogonal code period Toc, or each coherent addition period Tca. The influence of mutual interference waves among the transmission branches can be dispersed and the estimation accuracy of an arrival direction can be raised.

### [Another Variation]

Part of the configuration of the radar device described above may be physically separated from the rest of the configuration of the radar device. Communication units for mutual communication need to be provided, respectively.

Although various aspects of the embodiment are described above with reference to the drawings, it is needless to mention that the present disclosure is not limited to such examples. A person skilled in the art may arrive at variations or modifications within the scope recited in the claims, and the variations or modifications should be understood as belonging in the technical scope of the present disclosure as a matter of course. Also, the constituents of the above-described embodiment may be combined as desired within the scope not departing from the spirit of the disclosure.

Although in the present embodiment described above, the radar device is described while exemplified in a case where for example, hardware resources are used to constitute the radar device, the radar device may be partially constituted using software that cooperates with such hardware resources.

Each of the units, or constituents, of the radar device according to the present embodiment described above is typically implemented as large-scale integration (LSI), which is an integrated circuit. The LSI may be made as one chip individually, or may be made as one chip so as to include part or all of the constituents. Depending on the degree of the integration, the above-mentioned LSI may be also referred to as an integrated circuit (IC), system LSI, super LSI, or ultra LSI.

In addition, the circuit-integrating technique is not limited to the LSI, a personal circuit or a general-purpose processor may be used for the implementation. A field-programmable gate array (FPGA), which is programmable, or a reconfigurable processor, which is capable of reconfiguring the connection and setting of circuit cells inside LSI, may be utilized after manufacturing the LSI.

Moreover, when a circuit-integrating technique that replaces the LSI is brought by advance of a semiconductor technique or another derivative technique, each unit of the radar device may be integrated using the technique. Application of biotechnology and the like are possible.

### [Recapitulation of Present Disclosure]

A radar transmitter according to the present disclosure includes: a signal generator that generates a plurality of signals corresponding to a plurality of transmission branches; a modulator that modulates each of the plurality of signals generated; a frequency shifter that provides a frequency shift of each of one or more predetermined frequency shift amounts to each of the plurality of signals modulated, the predetermined frequency shift amount being an integral multiple of a predetermined period and differing among the plurality of transmission branches; and a radio transmitter that transmits the plurality of signals provided with the predetermined frequency shift as radar signals.

In the radar transmitter, the signal generator may include: a code generator that generates a plurality of pulse compression codes corresponding to the plurality of transmission branches; a transmission time controller that outputs the plurality of pulse compression codes in each of one or more predetermined transmission repetition periods; and an orthogonal encoder that generates the plurality of signals by multiplying the plurality of pulse compression codes output in each predetermined transmission repetition period by respective orthogonal codes different among the plurality of transmission branches, and the predetermined period may be at least one of an orthogonal code period of the orthogonal code, a coherent addition period of coherent addition included in signal processing, and a Doppler analysis period of Doppler analysis included in the signal processing.

Further, in the radar transmitter, the signal generator may include: a code generator that generates a plurality of pulse compression codes corresponding to the plurality of transmission branches using a complementary code; a transmission time controller that outputs the plurality of pulse compression codes in each of one or more predetermined transmission repetition periods; and an orthogonal encoder that generates the plurality of signals by multiplying the plurality of pulse compression codes output in each predetermined transmission repetition period by respective orthogonal codes different among the plurality of transmission branches, and the predetermined period may be at least one of a complementary code period of the complementary code, an orthogonal code period of the orthogonal code, a coherent addition period of coherent addition included in signal processing, and a Doppler analysis period of Doppler analysis included in the signal processing.

Further, in the radar transmitter, the orthogonal encoder may switch a plurality of bits that constitute the orthogonal code in each transmission repetition period or each complementary code period.

Further, in the radar transmitter, when the coherent addition period serves as a sample period of a Fourier transform, the frequency shift amount may be smaller than a maximum Doppler frequency band.

Further, in the radar transmitter, the frequency shift amount may be a center frequency of each of frequency bands obtained by dividing a Doppler frequency band equally.

Further, in the radar transmitter, the frequency shifter may multiply the plurality of signals by a value obtained by sampling a signal with a frequency of the frequency shift amount in each transmission repetition period, each complementary code period, each orthogonal code period, or each coherent addition period.

Further, in the radar transmitter, the frequency shifter may allocate the frequency shift amounts including zero to the plurality of transmission branches, respectively, and change the transmission branch to which the frequency shift amount of zero is allocated in each transmission repetition period, each complementary code period, each orthogonal code period, each coherent addition period, or each Doppler analysis period.

Further, in the radar transmitter, the frequency shifter may switch a polarity of the frequency shift amount in each transmission repetition period, each complementary code period, each orthogonal code period, each coherent addition period, or each Doppler analysis period.

Further, in the radar transmitter, the transmission time controller may output the plurality of signals at transmission timings different among the plurality of transmission branches in the transmission repetition period.

Further, in the radar transmitter, the transmission time controller may change the transmission timing of the signal in each transmission repetition period, each complementary code period, each orthogonal code period, each coherent addition period, or each Doppler analysis period.

A radar receiver according to an aspect of the present disclosure includes: a radio receiver including at least one reception branch that receives an echo signal being a radar signal reflected from a target; an echo signal processor that extracts a Doppler component from the received echo signal; and an arrival direction estimator that detects the target by referring to the extracted Doppler component, where the echo signal processor performs demodulation on the echo signal, performs Doppler analysis on a result of the demodulation, extracts corresponding part from a result of the Doppler analysis regarding each of one or more frequency shift amounts, and thus extracts the Doppler component regarding each of combinations of a plurality of transmission branches included in a radar transmitter that transmits the radar signal, and the at least one reception branch.

A radar receiver according to an aspect of the present disclosure includes: a radio receiver including at least one reception branch that receives an echo signal being a radar signal reflected from a target; an echo signal processor that extracts a Doppler component from the received echo signal; and an arrival direction estimator that detects the target by referring to the extracted Doppler component, where, with respect to each of one or more frequency shift amounts, the echo signal processor provides a frequency shift of the frequency shift amount to the echo signal, the frequency shift being identical in an absolute value and opposite in a polarity to the frequency shift amount, demodulates the echo signal after the frequency shift, performs Doppler analysis on the demodulated signal, and extracts a Doppler component regarding each of combinations of a plurality of transmission branches included in a radar transmitter that transmits the radar signal, and the at least one reception branch.

The present disclosure is useful as a radar transmitter and a radar receiver capable of detecting a target with high accuracy.

What is claimed is:

1. A radar transmitter comprising:
a signal generator that generates a plurality of signals, each signal corresponding to respective one of a plurality of transmission branches;
a modulator that modulates each of the plurality of generated signals;
a frequency shifter that provides one of a plurality of frequency shifts respectively to one of the plurality of modulated signals, where each of the plurality of frequency shifts has corresponding one of a plurality of frequency shift amounts, each frequency shift amount being a multiple of a predetermined period, and where each of the plurality of frequency shift amounts respectively corresponding to the plurality of transmission branches differ from each other; and
a radio transmitter that transmits the plurality of frequency shifted signals as radar signals.

2. The radar transmitter according to claim 1, wherein
the signal generator includes:
a code generator that generates a plurality of pulse compression codes respectively corresponding to the plurality of transmission branches;
a transmission time controller that outputs each of the plurality of generated pulse compression codes at a transmission repetition period; and
an orthogonal encoder that multiplies the output plurality of pulse compression codes by respective orthogonal codes that are different among the plurality of transmission branches and outputs the multiplying results as the plurality of signals, and
wherein the predetermined period is one of an orthogonal code period of the orthogonal codes, a coherent addition period of coherent addition included in received signal processing, and a Doppler analysis period of Doppler analysis included in the received signal processing.

3. The radar transmitter according to claim 1, wherein
the signal generator includes:
a code generator that generates a plurality of pulse compression codes respectively corresponding to the plurality of transmission branches by using a complementary code;
a transmission time controller that outputs each of the plurality of generated pulse compression codes at a transmission repetition period; and
an orthogonal encoder that multiplies the output plurality of pulse compression codes by respective orthogonal codes that are different among the plurality of transmission branches and outputs the multiplying results as the plurality of signals, and
wherein the predetermined period is one of a complementary code period of the complementary code, an orthogonal code period of the orthogonal codes, a coherent addition period of coherent addition included in received signal processing, and a Doppler analysis period of Doppler analysis included in the received signal processing.

4. The radar transmitter according to claim 3, wherein
the orthogonal encoder switches a plurality of bits that constitute one of the orthogonal codes at the transmission repetition period or at the complementary code period.

5. The radar transmitter according to claim 3, wherein
when the coherent addition period is a sample period of a Fourier transform, the frequency shift amount is smaller than a maximum Doppler frequency band.

6. The radar transmitter according to claim 5, wherein
the frequency shift amount is a center frequency of each of frequency bands obtained by dividing a Doppler frequency band equally.

7. The radar transmitter according to claim 3, wherein
the frequency shifter multiplies the plurality of modulated signals by a value obtained by sampling a signal with a frequency of the frequency shift amount at a period of one of a transmission repetition period, the complementary code period, the orthogonal code period, and the coherent addition period.

8. The radar transmitter according to claim 3, wherein
the frequency shifter allocates a plurality of frequency shift amounts including zero to the plurality of transmission branches, respectively, and changes a transmission branch to which the frequency shift amount of zero is allocated at a period of one of the transmission repetition period, the complementary code period, the orthogonal code period, the coherent addition period, and the Doppler analysis period.

9. The radar transmitter according to claim 3, wherein
the frequency shifter switches a polarity of the frequency shift amount at a period of one of the transmission repetition period, the complementary code period, the orthogonal code period, the coherent addition period, and the Doppler analysis period.

10. The radar transmitter according to claim 4, wherein
the transmission time controller outputs the plurality of generated pulse compression codes at transmission timings different among the plurality of transmission branches within the transmission repetition period.

11. The radar transmitter according to claim 10, wherein
the transmission time controller changes the transmission timings within the transmission repetition period, at a period of one of the transmission repetition period, the complementary code period, the orthogonal code period, the coherent addition period, and the Doppler analysis period.

12. A radar receiver comprising:
a radio receiver including at least one reception branch that receives an echo signal that is a radar signal reflected from a target;
an echo signal processor that extracts a Doppler component from the received echo signal; and
an arrival direction estimator that detects the target based on the extracted Doppler component, wherein
the echo signal processor performs demodulation of the received echo signal, performs Doppler analysis on the demodulation result, extracts corresponding portion from a result of the Doppler analysis for each of a plurality of frequency shift amounts, and thus extracts the Doppler component for each combination of a plurality of transmission branches included in a radar transmitter that transmits the radar signal, and the at least one reception branch.

13. A radar receiver comprising:
a radio receiver including at least one reception branch that receives an echo signal that is a radar signal reflected from a target;
an echo signal processor that extracts a Doppler component from the received echo signal; and
an arrival direction estimator that detects the target based on the extracted Doppler component, wherein
the echo signal processor provides one of a plurality of frequency shift to the echo signal, the frequency shift having a value identical in an absolute value and opposite in a polarity to the frequency shift amount, demodulates the frequency shifted echo signal, performs Doppler analysis on the demodulated signal, and extracts a Doppler component for each combination of a plurality of transmission branches included in a radar transmitter that transmits the radar signal, and the at least one reception branch.
